(19) United States
(12) Patent Application Publication
(10) Pub. No.: US 2023/0089863 A1
(43) Pub. Date: Mar. 23, 2023

(54) EXECUTABLE PASSING USING MAILBOX REGISTERS

(71) Applicant: Intel Corporation, Santa Clara, CA (US)

(72) Inventors: Shelly Kishore, Hillsboro, OR (US); Nivedita Aggarwal, Portland, OR (US); Vincent Zimmer, Issaquah, WA (US)

(73) Assignee: Intel Corporation, Santa Clara, CA (US)

(21) Appl. No.: 17/991,811

(22) Filed: Nov. 21, 2022

(51) Int. Cl. G06F 21/54; G06F 21/57

(52) U.S. Cl. CPC G06F 21/54; G06F 21/57

(57) ABSTRACT

A mailbox register is provided in local memory of a processor device, the processor device connected to a host processor device by an interconnect. The processor device accesses the mailbox register to determine that a ready value in the mailbox register identifies that an executable has been written to the mailbox register by the host processor device. The processor device reads the executable from the mailbox register and executes the executable to generate a result. The processor device writes an execution finished value to the mailbox register based on execution of the executable by the processor circuitry, which the host processor device can read to identify that execution of the executable is complete.

### FIELD

This disclosure pertains to computing systems, and in particular (but not exclusively) to computer interfaces.

### BACKGROUND

Advances in semi-conductor processing and logic design have permitted an increase in the amount of logic that may be present on integrated circuit devices. As a corollary, computer system configurations have evolved from a single or multiple integrated circuits in a system to multiple cores, multiple hardware threads, and multiple logical processors present on individual integrated circuits, as well as other interfaces integrated within such processors. A processor or integrated circuit typically comprises a single physical processor die, where the processor die may include any number of cores, hardware threads, logical processors, interfaces, memory, controller hubs, etc. As the processing power grows along with the number of devices in a computing system, the communication between sockets and other devices becomes more critical. Accordingly, interconnects, have grown from more traditional multi-drop buses that primarily handled electrical communications to full blown interconnect architectures that facilitate fast communication. Unfortunately, as the demand for future processors to consume at even higher-rates corresponding demand is placed on the capabilities of existing interconnect architectures. Interconnect architectures may be based on a variety of technologies, including Peripheral Component Interconnect Express (PCIe), Universal Serial Bus, and others.

### BRIEF DESCRIPTION OF THE DRAWINGS

FIG. 1 illustrates an embodiment of a computing system including an interconnect architecture.

FIG. 2 illustrates an embodiment of a interconnect architecture including a layered stack.

FIG. 3 illustrates an embodiment of a request or packet to be generated or received within an interconnect architecture.

FIG. 4 illustrates an embodiment of a transmitter and receiver pair for an interconnect architecture.

FIG. 5 illustrates an example implementation of a computing system including a host processor and an accelerator coupled by a link.

FIG. 6 illustrates an example implementation of a computing system including two or more interconnected processor devices.

FIG. 7 illustrates a representation of an example port of a device including a layered stack.

FIG. 8 is a simplified block diagram of an example system including multiple processor devices.

FIGS. 9A-9C are representations of example capability structures.

FIG. 10 is a simplified block diagram of an example host system memory map.

FIG. 11 is a simplified block diagram of an example processor device with a mailbox register implemented in local memory.

FIG. 12 is an example flow diagram illustrating use of an example mailbox register.

FIG. 13 illustrates an embodiment of a block diagram for a computing system including a multicore processor.

FIG. 14 illustrates another embodiment of a block diagram for a computing system.

### DETAILED DESCRIPTION

In the following description, numerous specific details are set forth, such as examples of specific types of processors and system configurations, specific hardware structures, specific architectural and micro architectural details, specific register configurations, specific instruction types, specific system components, specific measurements/heights, specific processor pipeline stages and operation etc. in order to provide a thorough understanding of the present disclosure. It will be apparent, however, to one skilled in the art that these specific details need not be employed to practice the present disclosure. In other instances, well known components or methods, such as specific and alternative processor architectures, specific logic circuits/code for described algorithms, specific firmware code, specific interconnect operation, specific logic configurations, specific manufacturing techniques and materials, specific compiler implementations, specific expression of algorithms in code, specific power down and gating techniques/logic and other specific operational details of computer system haven't been described in detail in order to avoid unnecessarily obscuring the present disclosure.

Although the following embodiments may be described with reference to energy conservation and energy efficiency in specific integrated circuits, such as in computing platforms or microprocessors, other embodiments are applicable to other types of integrated circuits and logic devices. Similar techniques and teachings of embodiments described herein may be applied to other types of circuits or semiconductor devices that may also benefit from better energy efficiency and energy conservation. For example, the disclosed embodiments are not limited to desktop computer systems or Ultrabooks™. And may be also used in other devices, such as handheld devices, tablets, other thin notebooks, systems on a chip (SOC) devices, and embedded applications. Some examples of handheld devices include cellular phones, Internet protocol devices, digital cameras, personal digital assistants (PDAs), and handheld PCs. Embedded applications typically include a microcontroller, a digital signal processor (DSP), a system on a chip, network computers (NetPC), set-top boxes, network hubs, wide area network (WAN) switches, or any other system that can perform the functions and operations taught below. Moreover, the apparatus', methods, and systems described herein are not limited to physical computing devices, but may also relate to software optimizations for energy conservation and efficiency.

As computing systems are advancing, the components therein are becoming more complex. As a result, the interconnect architecture to couple and communicate between the components is also increasing in complexity to ensure bandwidth requirements are met for optimal component operation. Furthermore, different market segments demand different aspects of interconnect architectures to suit the market's needs. For example, servers require higher performance, while the mobile ecosystem is sometimes able to sacrifice overall performance for power savings. Yet, it's a singular purpose of most fabrics to provide highest possible performance with maximum power saving. Below, a number of interconnects are discussed, which would potentially benefit from aspects of the solutions described herein.

One interconnect fabric architecture includes the Peripheral Component Interconnect (PCI) Express (PCIe) architecture. A primary goal of PCIe is to enable components and devices from different vendors to inter-operate in an open architecture, spanning multiple market segments; Clients (Desktops and Mobile), Servers (Standard and Enterprise), and Embedded and Communication devices. PCI Express is a high performance, general purpose I/O interconnect defined for a wide variety of future computing and communication platforms. Some PCI attributes, such as its usage model, load-store architecture, and software interfaces, have been maintained through its revisions, whereas previous parallel bus implementations have been replaced by a highly scalable, fully serial interface. The more recent versions of PCI Express take advantage of advances in point-to-point interconnects, Switch-based technology, and packetized protocol to deliver new levels of performance and features. Power Management, Quality Of Service (QoS), Hot-Plug/Hot-Swap support, Data Integrity, and Error Handling are among some of the advanced features supported by PCI Express.

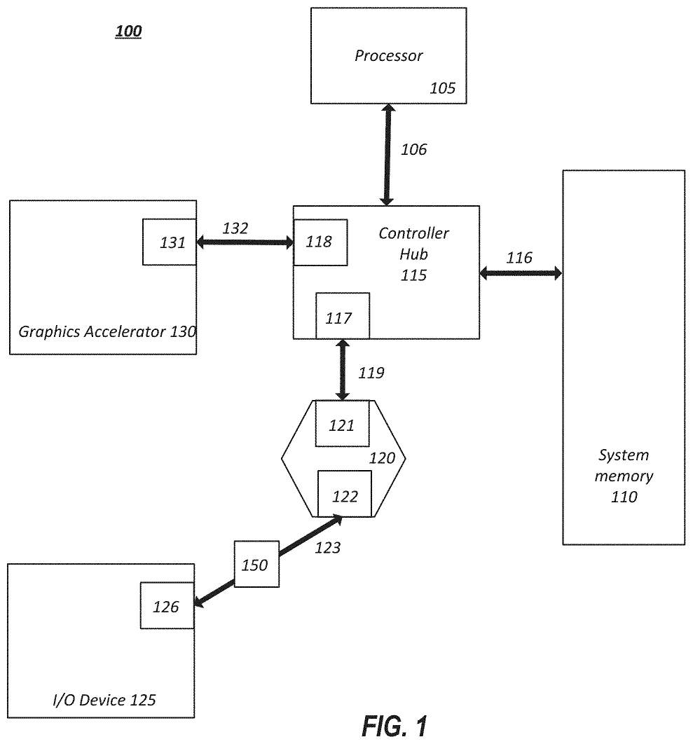

Referring to FIG. 1, an embodiment of a fabric composed of point-to-point Links that interconnect a set of components is illustrated. System 100 includes processor 105 and system memory 110 coupled to controller hub 115. Processor 105 includes any processing element, such as a microprocessor, a host processor, an embedded processor, a co-processor, or other processor. Processor 105 is coupled to controller hub 115 through front-side bus (FSB) 106. In one embodiment, FSB 106 is a serial point-to-point interconnect as described below. In another embodiment, link 106 includes a serial, differential interconnect architecture that is compliant with different interconnect standard.

System memory 110 includes any memory device, such as random access memory (RAM), non-volatile (NV) memory, or other memory accessible by devices in system 100. System memory 110 is coupled to controller hub 115 through memory interface 116. Examples of a memory interface include a double-data rate (DDR) memory interface, a dual-channel DDR memory interface, and a dynamic RAM (DRAM) memory interface.

In one embodiment, controller hub 115 is a root hub, root complex, or root controller in a Peripheral Component Interconnect Express (PCIe or PCIE) interconnection hierarchy. Examples of controller hub 115 include a chipset, a memory controller hub (MCH), a northbridge, an interconnect controller hub (ICH) a southbridge, and a root controller/hub. Often the term chipset refers to two physically separate controller hubs, e.g. a memory controller hub (MCH) coupled to an interconnect controller hub (ICH). Note that current systems often include the MCH integrated with processor 105, while controller 115 is to communicate with I/O devices, in a similar manner as described below. In some embodiments, peer-to-peer routing is optionally supported through root complex 115.

Here, controller hub 115 is coupled to switch/bridge 120 through serial link 119. Input/output modules 117 and 121, which may also be referred to as interfaces/ports 117 and 121, include/implement a layered protocol stack to provide communication between controller hub 115 and switch 120. In one embodiment, multiple devices are capable of being coupled to switch 120.

Switch/bridge 120 routes packets/messages from device 125 upstream, e.g. up a hierarchy towards a root complex, to controller hub 115 and downstream, e.g. down a hierarchy away from a root controller, from processor 105 or system memory 110 to device 125. Switch 120, in one embodiment, is referred to as a logical assembly of multiple virtual PCI-to-PCI bridge devices. Device 125 includes any internal or external device or component to be coupled to an electronic system, such as an I/O device, a Network Interface Controller (NIC), an add-in card, an audio processor, a network processor, a hard-drive, a storage device, a CD/DVD ROM, a monitor, a printer, a mouse, a keyboard, a router, a portable storage device, a Firewire device, a Universal Serial Bus (USB) device, a scanner, and other input/output devices. Often in the PCIe vernacular, such as device, is referred to as an endpoint. Although not specifically shown, device 125 may include a PCIe to PCl/PCI-X bridge to support legacy or other version PCI devices. Endpoint devices in PCIe are often classified as legacy, PCIe, or root complex integrated endpoints.

Graphics accelerator 130 is also coupled to controller hub 115 through serial link 132. In one embodiment, graphics accelerator 130 is coupled to an MCH, which is coupled to an ICH. Switch 120, and accordingly I/O device 125, is then coupled to the ICH. I/O modules 131 and 118 are also to implement a layered protocol stack to communicate between graphics accelerator 130 and controller hub 115. Similar to the MCH discussion above, a graphics controller or the graphics accelerator 130 itself may be integrated in processor 105. It should be appreciated that one or more of the components (e.g., 105, 110, 115, 120, 125, 130) illustrated in FIG. 1 can be enhanced to execute, store, and/or embody logic to implement one or more of the features described herein.

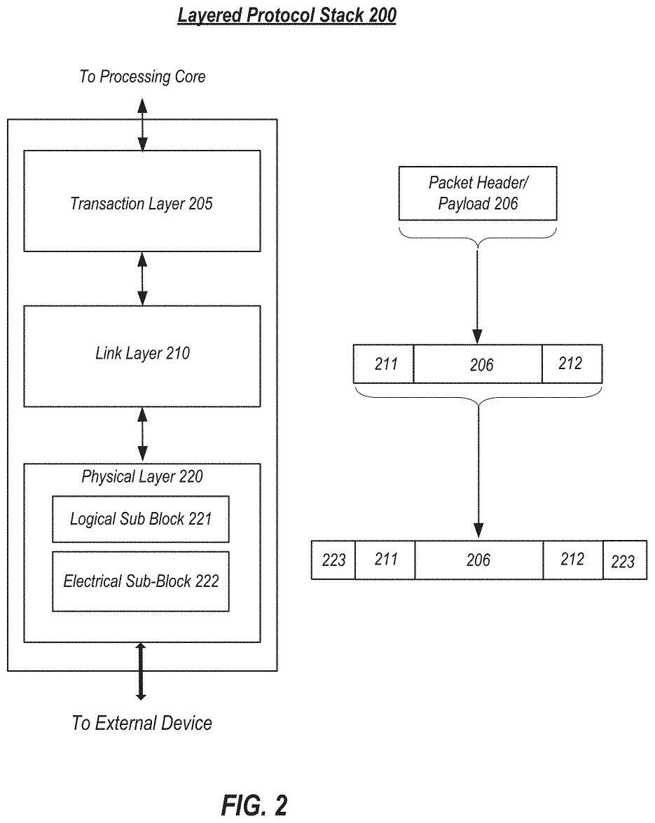

Turning to FIG. 2 an embodiment of a layered protocol stack is illustrated. Layered protocol stack 200 includes any form of a layered communication stack, such as a Quick Path Interconnect (QPI) stack, a PCIe stack, a next generation high performance computing interconnect stack, or other layered stack. Although the discussion immediately below in reference to FIGS. 1-4 are in relation to a PCIe stack, the same concepts may be applied to other interconnect stacks. In one embodiment, protocol stack 200 is a PCIe protocol stack including transaction layer 205, link layer 210, and physical layer 220. An interface, such as interfaces 117, 118, 121, 122, 126, and 131 in FIG. 1, may be represented as communication protocol stack 200. Representation as a communication protocol stack may also be referred to as a module or interface implementing/including a protocol stack.

PCI Express uses packets to communicate information between components. Packets are formed in the Transaction Layer 205 and Data Link Layer 210 to carry the information from the transmitting component to the receiving component. As the transmitted packets flow through the other layers, they are extended with additional information necessary to handle packets at those layers. At the receiving side the reverse process occurs and packets get transformed from their Physical Layer 220 representation to the Data Link Layer 210 representation and finally (for Transaction Layer Packets) to the form that can be processed by the Transaction Layer 205 of the receiving device.

### Transaction Layer

In one embodiment, transaction layer 205 is to provide an interface between a device's processing core and the interconnect architecture, such as data link layer 210 and physical layer 220. In this regard, a primary responsibility of the transaction layer 205 is the assembly and disassembly of packets (e.g., transaction layer packets, or TLPs). The translation layer 205 typically manages credit-based flow control for TLPs. PCIe implements split transactions, e.g. transactions with request and response separated by time, allowing a link to carry other traffic while the target device gathers data for the response.

In addition PCIe utilizes credit-based flow control. In this scheme, a device advertises an initial amount of credit for each of the receive buffers in Transaction Layer 205. An external device at the opposite end of the link, such as controller hub 115 in FIG. 1, counts the number of credits consumed by each TLP. A transaction may be transmitted if the transaction does not exceed a credit limit. Upon receiving a response an amount of credit is restored. An advantage of a credit scheme is that the latency of credit return does not affect performance, provided that the credit limit is not encountered.

In one embodiment, four transaction address spaces include a configuration address space, a memory address space, an input/output address space, and a message address space. Memory space transactions include one or more of read requests and write requests to transfer data to/from a memory-mapped location. In one embodiment, memory space transactions are capable of using two different address formats, e.g., a short address format, such as a 32-bit address, or a long address format, such as 64-bit address. Configuration space transactions are used to access configuration space of the PCIe devices. Transactions to the configuration space include read requests and write requests. Message transactions are defined to support in-band communication between PCIe agents.

Therefore, in one embodiment, transaction layer 205 assembles packet header/payload 156. Format for current packet headers/payloads may be found in the PCIe specification at the PCIe specification website.

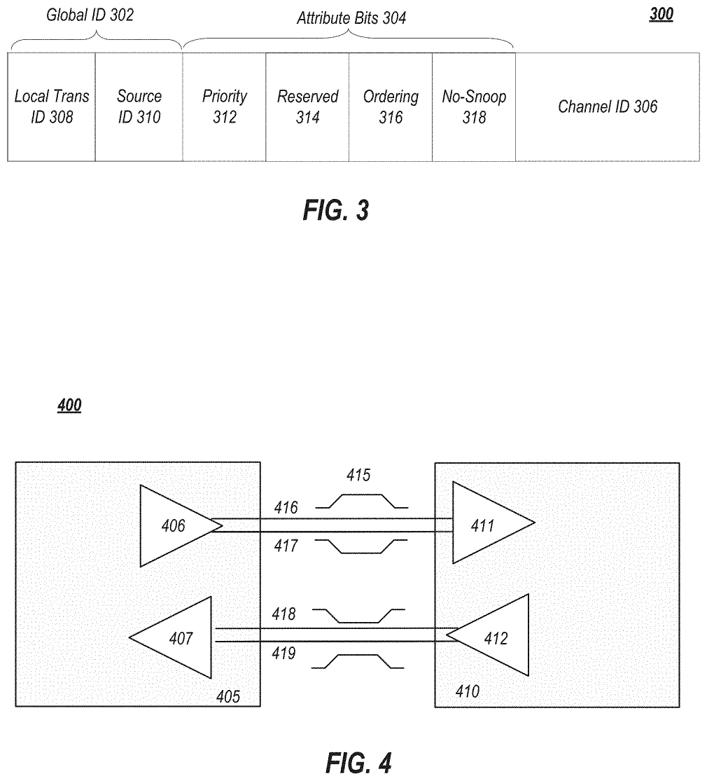

Quickly referring to FIG. 3, an embodiment of a PCIe transaction descriptor is illustrated. In one embodiment, transaction descriptor 300 is a mechanism for carrying transaction information. In this regard, transaction descriptor 300 supports identification of transactions in a system. Other potential uses include tracking modifications of default transaction ordering and association of transaction with channels.

Transaction descriptor 300 includes global identifier field 302, attributes field 304 and channel identifier field 306. In the illustrated example, global identifier field 302 is depicted comprising local transaction identifier field 308 and source identifier field 310. In one embodiment, global transaction identifier 302 is unique for all outstanding requests.

According to one implementation, local transaction identifier field 308 is a field generated by a requesting agent, and it is unique for all outstanding requests that require a completion for that requesting agent. Furthermore, in this example, source identifier 310 uniquely identifies the requestor agent within a PCIe hierarchy. Accordingly, together with source ID 310, local transaction identifier 308 field provides global identification of a transaction within a hierarchy domain.

Attributes field 304 specifies characteristics and relationships of the transaction. In this regard, attributes field 304 is potentially used to provide additional information that allows modification of the default handling of transactions. In one embodiment, attributes field 304 includes priority field 312, reserved field 314, ordering field 316, and no-snoop field 318. Here, priority sub-field 312 may be modified by an initiator to assign a priority to the transaction. Reserved attribute field 314 is left reserved for future, or vendor-defined usage. Possible usage models using priority or security attributes may be implemented using the reserved attribute field.

In this example, ordering attribute field 316 is used to supply optional information conveying the type of ordering that may modify default ordering rules. According to one example implementation, an ordering attribute of “0” denotes default ordering rules are to apply, wherein an ordering attribute of “1” denotes relaxed ordering, wherein writes can pass writes in the same direction, and read completions can pass writes in the same direction. Snoop attribute field 318 is utilized to determine if transactions are snooped. As shown, channel ID Field 306 identifies a channel that a transaction is associated with.

### Link Layer

Link layer 210, also referred to as data link layer 210, acts as an intermediate stage between transaction layer 205 and the physical layer 220. In one embodiment, a responsibility of the data link layer 210 is providing a reliable mechanism for exchanging Transaction Layer Packets (TLPs) between two components a link. One side of the Data Link Layer 210 accepts TLPs assembled by the Transaction Layer 205, applies packet sequence identifier 211, e.g. an identification number or packet number, calculates and applies an error detection code, e.g. CRC 212, and submits the modified TLPs to the Physical Layer 220 for transmission across a physical to an external device.

### Physical Layer

In one embodiment, physical layer 220 includes logical sub block 221 and electrical sub-block 222 to physically transmit a packet to an external device. Here, logical sub-block 221 is responsible for the “digital” functions of Physical Layer 221. In this regard, the logical sub-block includes a transmit section to prepare outgoing information for transmission by physical sub-block 222, and a receiver section to identify and prepare received information before passing it to the Link Layer 210.

Physical block 222 includes a transmitter and a receiver. The transmitter is supplied by logical sub-block 221 with symbols, which the transmitter serializes and transmits onto to an external device. The receiver is supplied with serialized symbols from an external device and transforms the received signals into a bit-stream. The bit-stream is de-serialized and supplied to logical sub-block 221. In one embodiment, an 8b/10b transmission code is employed, where ten-bit symbols are transmitted/received. Here, special symbols are used to frame a packet with frames 223. In addition, in one example, the receiver also provides a symbol clock recovered from the incoming serial stream.

As stated above, although transaction layer 205, link layer 210, and physical layer 220 are discussed in reference to a specific embodiment of a PCIe protocol stack, a layered protocol stack is not so limited. In fact, any layered protocol may be included/implemented. As an example, an port/interface that is represented as a layered protocol includes: (1) a first layer to assemble packets, e.g. a transaction layer; a second layer to sequence packets, e.g. a link layer; and a third layer to transmit the packets, e.g. a physical layer. As a specific example, a common standard interface (CSI) layered protocol is utilized.

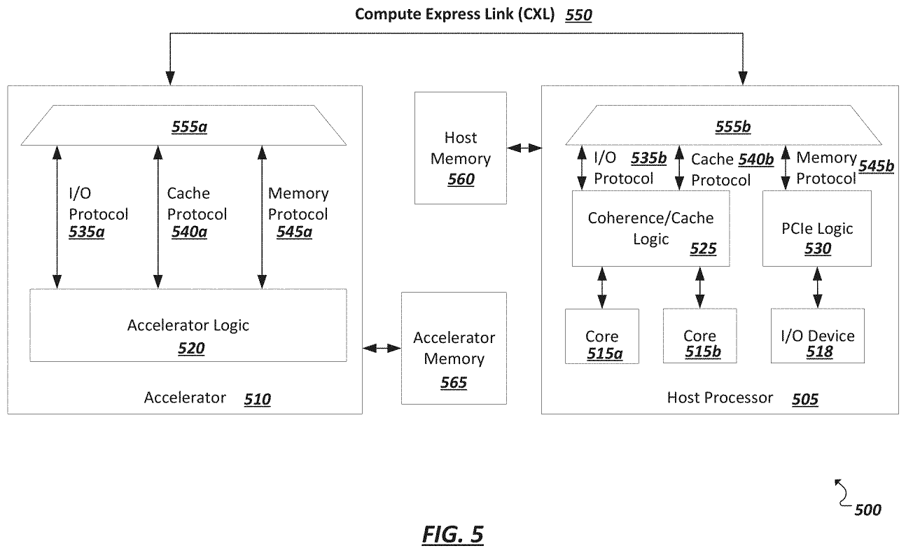

Referring next to FIG. 4, an embodiment of a PCIe serial point to point fabric is illustrated. Although an embodiment of a PCIe serial point-to-point link is illustrated, a serial point-to-point link is not so limited, as it includes any transmission path for transmitting serial data. In the embodiment shown, a basic PCIe link includes two, low-voltage, differentially driven signal pairs: a transmit pair 406/412 and a receive pair 411/407. Accordingly, device 405 includes transmission logic 406 to transmit data to device 410 and receiving logic 407 to receive data from device 410. In other words, two transmitting paths, e.g. paths 416 and 417, and two receiving paths, e.g. paths 418 and 419, are included in a PCIe link.

A transmission path refers to any path for transmitting data, such as a transmission line, a copper line, an optical line, a wireless communication channel, an infrared communication link, or other communication path. A connection between two devices, such as device 405 and device 410, is referred to as a link, such as link 415. A link may support one lane — each lane representing a set of differential signal pairs (one pair for transmission, one pair for reception). To scale bandwidth, a link may aggregate multiple lanes denoted by xN, where N is any supported Link width, such as 1, 2, 4, 8, 12, 16, 32, 64, or wider. In some implementations, each symmetric lane contains one transmit differential pair and one receive differential pair. Asymmetric lanes can contain unequal ratios of transmit and receive pairs. Some technologies can utilize symmetric lanes (e.g., PCIe), while others (e.g., Displayport) may not and may even including only transmit or only receive pairs, among other examples.

A differential pair refers to two transmission paths, such as lines 416 and 417, to transmit differential signals. As an example, when line 416 toggles from a low voltage level to a high voltage level, e.g. a rising edge, line 417 drives from a high logic level to a low logic level, e.g. a falling edge. Differential signals potentially demonstrate better electrical characteristics, such as better signal integrity, e.g. cross-coupling, voltage overshoot/undershoot, ringing, etc. This allows for better timing window, which enables faster transmission frequencies.

A variety of interconnect architectures and protocols may utilize the concepts discussed herein. With advancements in computing systems and performance requirements, improvements to interconnect fabric and link implementations continue to be developed, including interconnects based on or utilizing elements of PCIe or other legacy interconnect platforms. In one example, Compute Express Link (CXL) has been developed, providing an improved, high-speed CPU-to-device and CPU-to-memory interconnect designed to accelerate next-generation data center performance, among other application. CXL maintains memory coherency between the CPU memory space and memory on attached devices, which allows resource sharing for higher performance, reduced software stack complexity, and lower overall system cost, among other example advantages. CXL enables communication between host processors (e.g., CPUs) and a set of workload accelerators (e.g., graphics processing units (GPUs), field programmable gate array (FPGA) devices, tensor and vector processor units, machine learning accelerators, purpose-built accelerator solutions, among other examples). Indeed, CXL is designed to provide a standard interface for high-speed communications, as accelerators are increasingly used to complement CPUs in support of emerging computing applications such as artificial intelligence, machine learning and other applications.

A CXL link may be a low-latency, high-bandwidth discrete or on-package link that supports dynamic protocol multiplexing of coherency, memory access, and input/output (I/O) protocols. Among other applications, a CXL link may enable an accelerator to access system memory as a caching agent and/or host system memory, among other examples. CXL is a dynamic multi-protocol technology designed to support a vast spectrum of accelerators. CXL provides a rich set of protocols that include I/O semantics similar to PCIe (CXL.io), caching protocol semantics (CXL.cache), and memory access semantics (CXL.mem) over a discrete or on-package link. Based on the particular accelerator usage model, all of the CXL protocols or only a subset of the protocols may be enabled. In some implementations, CXL may be built upon the well-established, widely adopted PCIe infrastructure (e.g., PCIe 5.0), leveraging the PCIe physical and electrical interface to provide advanced protocol in areas include I/O, memory protocol (e.g., allowing a host processor to share memory with an accelerator device), and coherency interface.

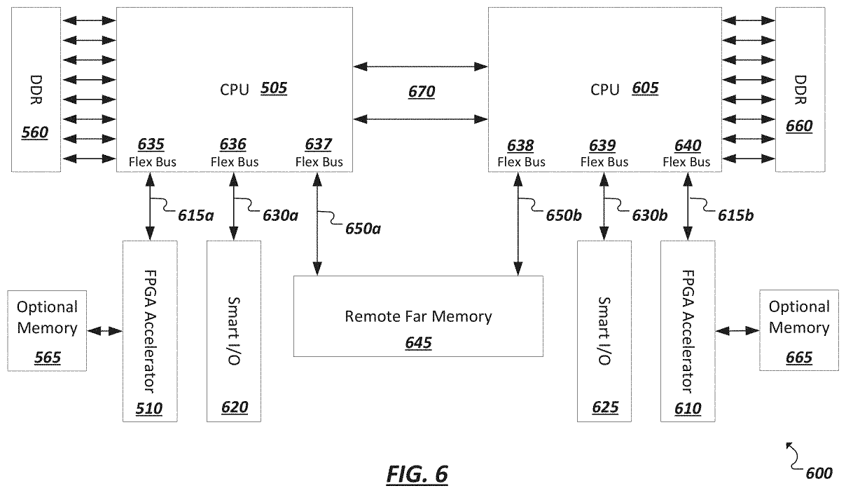

Turning to FIG. 5, a simplified block diagram 500 is shown illustrating an example system utilizing a CXL link 550. For instance, the link 550 may interconnect a host processor 505 (e.g., CPU) to an accelerator device 510. In this example, the host processor 505 includes one or more processor cores (e.g., 515a-b) and one or more I/O devices (e.g., 518). Host memory (e.g., 560) may be provided with the host processor (e.g., on the same package or die). The accelerator device 510 may include accelerator logic 520 and, in some implementations, may include its own memory (e.g., accelerator memory 565). In this example, the host processor 505 may include circuitry to implement coherence/cache logic 525 and interconnect logic (e.g., PCIe logic 530). CXL multiplexing logic (e.g., 555a-b) may also be provided to enable multiplexing of CXL protocols (e.g., I/O protocol 535a-b(e.g., CXL.io), caching protocol 540a-b(e.g., CXL.cache), and memory access protocol 545a-b(CXL.mem)), thereby enabling data of any one of the supported protocols (e.g., 535a-b, 540a-b, 545a-b) to be sent, in a multiplexed manner, over the link 550 between host processor 505 and accelerator device 510.

In some implementations, a Flex Bus™ port may be utilized in concert with CXL-compliant links to flexibly adapt a device to interconnect with a wide variety of other devices (e.g., other processor devices, accelerators, switches, memory devices, etc.). A Flex Bus port is a flexible high-speed port that is statically configured to support either a PCIe or CXL link (and potentially also links of other protocols and architectures). A Flex Bus port allows designs to choose between providing native PCIe protocol or CXL over a high-bandwidth, off-package link. Selection of the protocol applied at the port may happen during boot time via auto negotiation and be based on the device that is plugged into the slot. Flex Bus uses PCIe electricals, making it compatible with PCIe retimers, and adheres to standard PCIe form factors for an add-in card.

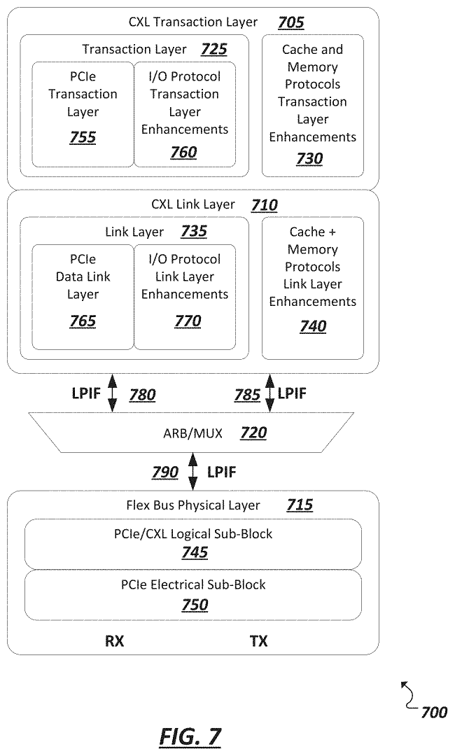

Turning to FIG. 6, an example is shown (in simplified block diagram 600) of a system utilizing Flex Bus ports (e.g., 635-640) to implement CXL (e.g., 615a-b, 650a-b) and PCIe links (e.g., 630a-b) to couple a variety of devices (e.g., 510, 610, 620, 625, 645, etc.) to a host processor (e.g., CPU 505, 605). In this example, a system may include two CPU host processor devices (e.g., 505, 605) interconnected by an inter-processor link 670 (e.g., utilizing a UltraPath Interconnect (UPI), Infinity Fabric™, or other interconnect protocol). Each host processor device 505, 605 may be coupled to local system memory blocks 560, 660 (e.g., double data rate (DDR) memory devices), coupled to the respective host processor 505, 605 via a memory interface (e.g., memory bus or other interconnect).

As discussed above, CXL links (e.g., 615a, 650b) may be utilized to interconnect a variety of accelerator devices (e.g., 510, 610). Accordingly, corresponding ports (e.g., Flex Bus ports 635, 640) may be configured (e.g., CXL mode selected) to enable CXL links to be established and interconnect corresponding host processor devices (e.g., 505, 605) to accelerator devices (e.g., 510, 610). As shown in this example, Flex Bus ports (e.g., 636, 639), or other similarly configurable ports, may be configured to implement general purpose I/O links (e.g., PCIe links) 630a-binstead of CXL links, to interconnect the host processor (e.g., 505, 605) to I/O devices (e.g., smart I/O devices 620, 625, etc.). In some implementations, memory of the host processor 505 may be expanded, for instance, through the memory (e.g., 565, 665) of connected accelerator devices (e.g., 510, 610), or memory extender devices (e.g., 645, connected to the host processor(s) 505, 605 via corresponding CXL links (e.g., 650a-b) implemented on Flex Bus ports (637, 638), among other example implementations and architectures.

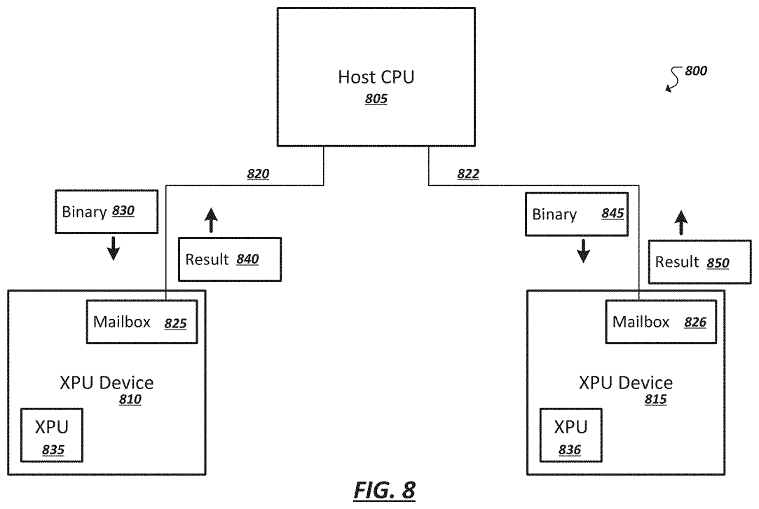

FIG. 7 is a simplified block diagram illustrating an example port architecture 700 (e.g., Flex Bus) utilized to implement CXL links. For instance, Flex Bus architecture may be organized as multiple layers to implement the multiple protocols supported by the port. For instance, the port may include transaction layer logic (e.g., 705), link layer logic (e.g., 710), and physical layer logic (e.g., 715) (e.g., implemented all or in-part in circuitry). For instance, a transaction (or protocol) layer (e.g., 705) may be subdivided into transaction layer logic 725 that implements a PCIe transaction layer 755 and CXL transaction layer enhancements 760 (for CXL.io) of a base PCIe transaction layer 755, and logic 730 to implement cache (e.g., CXL.cache) and memory (e.g., CXL.mem) protocols for a CXL link. Similarly, link layer logic 735 may be provided to implement a base PCIe data link layer 765 and a CXL link layer (for CX1.io) representing an enhanced version of the PCIe data link layer 765. A CXL link layer 710 may also include cache and memory link layer enhancement logic 740 (e.g., for CXL.cache and CXL.mem).

Continuing with the example of FIG. 7, a CXL link layer logic 710 may interface with CXL arbitration/multiplexing (ARB/MUX) logic 720, which interleaves the traffic from the two logic streams (e.g., PCIe/CXL.io and CXL.cache/CXL.mem), among other example implementations. During link training, the transaction and link layers are configured to operate in either PCIe mode or CXL mode. In some instances, a host CPU may support implementation of either PCIe or CXL mode, while other devices, such as accelerators, may only support CXL mode, among other examples. In some implementations, the port (e.g., a Flex Bus port) may utilize a physical layer 715 based on a PCIe physical layer (e.g., PCIe electrical PHY 750). For instance, a Flex Bus physical layer may be implemented as a converged logical physical layer 745 that can operate in either PCIe mode or CXL mode based on results of alternate mode negotiation during the link training process. In some implementations, the physical layer may support multiple signaling rates (e.g., 8 GT/s, 16 GT/s, 32 GT/s, etc.) and multiple link widths (e.g., x16, x8, x4, x2, x1, etc.). In PCIe mode, links implemented by the port 700 may be fully compliant with native PCIe features (e.g., as defined in the PCIe specification), while in CXL mode, the link supports all features defined for CXL. Accordingly, a Flex Bus port may provide a point-to-point interconnect that can transmit native PCIe protocol data or dynamic multi-protocol CXL data to provide I/O, coherency, and memory protocols, over PCIe electricals, among other examples.

The CXL I/O protocol, CXL.io, provides a non-coherent load/store interface for I/O devices. Transaction types, transaction packet formatting, credit-based flow control, virtual channel management, and transaction ordering rules in CXL.io may follow all or a portion of the PCIe definition. CXL cache coherency protocol, CXL.cache, defines the interactions between the device and host as a number of requests that each have at least one associated response message and sometimes a data transfer. The interface consists of three channels in each direction: Request, Response, and Data.

The CXL memory protocol, CXL.mem, is a transactional interface between the processor and memory and uses the physical and link layers of CXL when communicating across dies. CXL.mem can be used for multiple different memory attach options including when a memory controller is located in the host CPU, when the memory controller is within an accelerator device, or when the memory controller is moved to a memory buffer chip, among other examples. CXL.mem may be applied to transaction involving different memory types (e.g., volatile, persistent, etc.) and configurations (e.g., flat, hierarchical, etc.), among other example features. In some implementations, a coherency engine of the host processor may interface with memory using CXL.mem requests and responses. In this configuration, the CPU coherency engine is regarded as the CXL.mem Master and the Mem device is regarded as the CXL.mem Subordinate. The CXL.mem Master is the agent which is responsible for sourcing CXL.mem requests (e.g., reads, writes, etc.) and a CXL.mem Subordinate is the agent which is responsible for responding to CXL.mem requests (e.g., data, completions, etc.). When the Subordinate is an accelerator, CXL.mem protocol assumes the presence of a device coherency engine (DCOH). This agent is assumed to be responsible for implementing coherency related functions such as snooping of device caches based on CXL.mem commands and update of metadata fields. In implementations, where metadata is supported by device-attached memory, it can be used by the host to implement a coarse snoop filter for CPU sockets, among other example uses.

In some implementations, an interface may be provided to couple circuitry or other logic (e.g., an intellectual property (IP) block or other hardware element) implementing a link layer (e.g., 710) to circuitry or other logic (e.g., an IP block or other hardware element) implementing at least a portion of a physical layer (e.g., 715) of a protocol. For instance, an interface may be defined and implemented between a link layer controller, module, or other logic and a module implementing a logical physical layer (“logical PHY” or “logPHY”) to facilitate interoperability, design and validation re-use between one or more link layers and a physical layer for an interface to a physical interconnect, such as in the example of FIG. 7. Additionally, as in the example of FIG. 7, an interface may be implemented with logic (e.g., 735, 740) to simultaneously implement and support multiple protocols. Further, in such implementations, an arbitration and multiplexer layer (e.g., 720) may be provided between the link layer (e.g., 710) and the physical layer (e.g., 715). In some implementations, each block (e.g., 715, 720, 735, 740) in the multiple protocol implementation may interface with the other block via an independent interface (e.g., 780, 785, 790). In cases where bifurcation is supported, each bifurcated port may likewise have its own interface, among other examples.

While examples discussed herein may reference the use of LPIF-based link layer-logical PHY interfaces, it should be appreciated that the details and principles discussed herein may be equally applied to non-LPIF interfaces. Likewise, while some examples may reference the use of common link layer-logical PHY interfaces to couple a PHY to controllers implement CXL or PCIe, other link layer protocols may also make use of such interfaces. Similarly, while some references may be made to Flex Bus physical layers, other physical layer logic may likewise be employed in some implementations and make use of common link layer-logical PHY interfaces, such as discussed herein, among other example variations that are within the scope of the present disclosure.

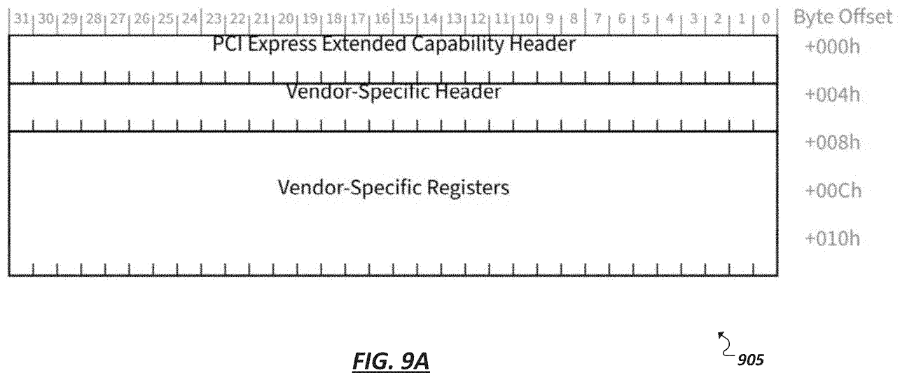

Modern system architectures are being developed to facilitate next generation computing workloads, including machine learning, artificial intelligence, and other emerging applications. Such systems may advantageously utilize multiple different types of devices, including specialized processing blocks, hardware accelerator blocks, memory controllers, network controllers, and other intellectual property blocks (or computing blocks). Heterogenous systems may be constructed from such different computing blocks and interconnected utilizing point-to-point interconnects to facilitate communication between the computing blocks. FIG. 8 is a simplified block diagram is an example of heterogenous computing system 800. For instance, the system 800 may include a host processor device 805 (e.g., a host CPU with a root complex or other processor device serving as a host within an interconnect hierarchy). In some implementations, the host processor 805 may execute programs (e.g., an operating system) to orchestrate the execution of applications using the system. In some cases, code and instructions embodying an application or program may be executed exclusively using the host processor. In some cases, the host processor may be a multicore or other processor for general purpose computing. A heterogenous system 800 may include multiple other devices that include processing hardware (e.g., XPUs), including other CPUs, graphic processing units (CPUs), tensor processing units (TPUs), network processing units (NPUs), infrastructure processing units (IPUs), hardware accelerators, field programmable gate array (FPGA) device, application specific integrated circuit (ASIC) devices, and other processing blocks. Such XPU devices (e.g., 810, 815, etc.) may have local memory or even attached memory, among other resources, which may be leveraged within the system 800 to perform various applications. Various interconnect technologies may be employed to interconnect the XPU devices 810, 815 with the host processor 805, as well as (in some cases) with each other. In some instances, the interconnects (e.g., 820, 822) may be implemented using layered interconnect protocols, such as PCIe, CXL, GenZ, Infinity Fabric, UPI, UCIe, among other example interconnect technologies. In some implementations, intermediate switches or bridges may be utilized to facilitate interconnections between the blocks in the system 800. Further, each device (e.g., 805, 810, 815) may be equipped with respective port hardware to implement all or a portion of the protocol stack(s) utilized on the interconnects, among other example logic.

In traditional heterogenous systems, XPU devices may be equipped with their own native executables tailored to the XPUs of the device. Such XPU devices may be limited to using these embedded or pre-loaded executable logic in concert with the code executed by the host processor to cooperate in the implementation of an application. For instance, on a typical client system, various discrete components may be provided, such as discrete graphics cards, lid controller hub (LCH), discrete network connective integration block (e.g., a CNVi interface for WiFi and/or Bluetooth radios), discrete Type-C Sub-System (TCSS) devices, FPGAs, etc., which have their own microcontrollers or processing circuitry (XPU). However, in traditional systems, there is no mechanism for the host to supply these XPUs with application-specific executables (e.g., via the interconnect(s) coupling the host to these discrete XPU devices). Instead, traditional XPU devices are limited to running the code already embedded on the device. Such limitations inhibit the heterogenous resources of the system from being fully and flexibly leveraged for various new and emerging applications and use cases. For instance, in traditional systems there may be no other way to use XPU devices to run signed code which may be provided by the host (e.g., in accordance with a particular application). Moreover, running the code on the host fails to solve these issues, as a conventional host is unable to directly access all the resources on discrete devices due to various security reasons. Further, conventional interconnect hierarchies do not allow the direct access and use of the compute capabilities of the discrete devices (at the direction of the CPU), in spite of such access potentially unlocking many new and innovative use cases and applications, among other example issues.

In an improved system, particularly defined registers may be implemented to serve as mailboxes (also referred to herein as “mailbox registers”) (e.g., 825, 826) through which a host processor may trigger and execute XPU native binaries on discrete XPU components. An XPU device may be an endpoint device, configured to couple to other devices (e.g., other XPU devices, switches, and other interconnect infrastructure), which include processing hardware (or an XPU (e.g., 835, 836)) enabling the device to execute binary executables or other code. In one example, a PCIe compatible host and XPU devices may utilize a corresponding, new PCIe capability exposed to the XPU and the host, which defines the use of a corresponding mailbox register (e.g., in association with a capability identified in configuration space of the XPU). The host device 805 (e.g., a host CPU) may make use of this mailbox register (e.g., 825) to engage in host-to-XPU mailbox communication to pass native executable binaries (e.g., 830) to discrete components to run on their XPU. The mailbox register may be further utilized to enable the host to retrieve any outputs or results (e.g., 840), which the host may then use in execution of subsequent binaries within the application, among other examples. Indeed, a host device (e.g., 805) may couple to multiple XPU devices (e.g., 810, 815) including XPU devices of different types and processing capabilities. Each XPU device that support the mailbox communication capability may receive executables (e.g., 830, 845) from the host device 805 through its respective mailbox register (e.g., 825, 826). Likewise, results (e.g., 840, 850) generated by the XPUs (e.g., 835, 836) through execution of the binary executable (e.g., 830, 845) may be “passed” back to the host device 805 through the mailboxes 825, 826, with the host device 805 accessing the resulting data 840, 850 through reads to the corresponding mailboxes 825, 826. In this manner, a heterogeneous processor system may be leveraged to enable programs to be run on multiple different platforms by allowing a host device 805 to deliver binary executables to various XPUs of different types through mailbox registers using existing interconnect technologies and protocols (e.g., PCIe, CXL, Infinity, etc.).

Enabling hosts to push application-specific executables to other XPUs hosted on discrete components in a heterogeneous system extends the functionality and logic of the discrete components and enable new utilizations and applications in the system. Such a solution may also be utilized within testing and debugging of the system and its constituent components. Moreover, such a solution may be implemented without the addition of additional discrete hardware components, thereby allowing such enhancements to be made to protocol circuitry of the devices' ports without additional hardware cost. Without having a capability for a host to dynamically supply application-specific native executables to appropriate XPUs in the system, computing resources of the system may be perpetually underutilized. For instance, some of the processing hardware of the XPU devices may be particularly well suited to execute binaries associated with particular workloads within an application, however, such binaries, within a production environment, may not be able to be added to the XPUs in the field without explicitly updating the firmware of the discrete device. Such a solution may open the door to new and improved applications and use cases of heterogeneous platforms and interconnect hierarchies, among other example advantages.

In some implementations, a protocol governing communication over an interconnect coupling a host processor device (e.g., a host CPU) to an XPU device within a system may define a configuration space within memory of the XPU device and/or CPU. The configuration space may be utilized to implement various capability registers, control registers, status registers, and/or other data structures utilized by the CPU and/or XPU device to configure intercommunication over the interconnect, including the configuration of a communication link over the physical interconnect in accordance with the protocol. As an example, ports of the CPU and XPU device may support and implement a PCIe-based protocol to establish a PCIe link over the interconnect between the CPU and XPU device. A new PCIe capability may be defined corresponding to a solution for utilizing a mailbox to enable a host to pass executables to the XPU. The mailbox register may be implemented in the configuration space of the XPU device's local memory. Alternatively, the mailbox may be implemented in a portion of the XPU's memory-mapped IO (MMIO) device memory, among other examples. Indeed, the mailbox register may be implemented as a PCIe capability register (e.g., a vendor-specific extended capability (VSEC) register), in some implementations. This PCIe capability may be exposed by the XPU device to the host to identify to the host that the XPU device supports the passing of native executables to the XPU device via mailbox register. As such, the new capability may leverage features defined in the PCIe specification, thereby allowing this new capability to be added without disrupting or changing core functionality of the interconnect protocol. This solution may be likewise applied to other interconnect protocols, such as CXL and others, where configuration space is provided in XPU devices. Such configuration space may be likewise utilized to define a mailbox register (e.g., along with potentially other configuration registers) which may be written to and read from by a host device to enable the passing of executables (and results of the executables' execution) between the host device and the XPU device(s).

As one example, PCIe devices can expose multiple base address register (BARs) in association with various capabilities offered on an interconnect. One (or multiple) of the BARs may be used for passing, triggering and executing XPU native binaries on discrete PCIe based components from a host processor device. For instance, one vendor specific register in the XPU device's PCIe configuration space may expose a list of BAR(s) having the capability so that host software may know which portions of the XPU device's memory can be used for this purpose. In one example, the BAR(s) listed in the vendor specific register may be a MEM BARs and should expose the size of device local memory that will be used for used for this capability, among other example implementations.

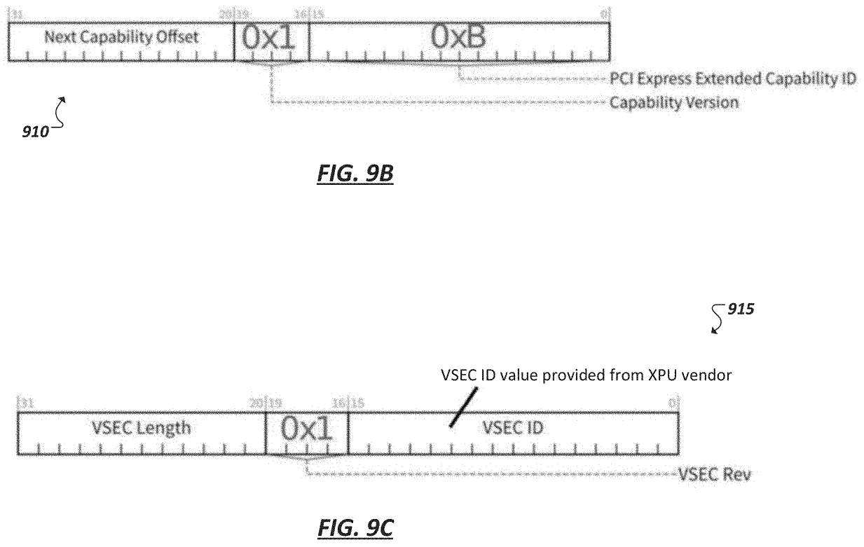

Versions of a PCIe (or CXL) specification may allow a compatible XPU device (e.g., a PCIe XPU device) to enable various existing and new vendor-specific capabilities. To implement binary executable passing using mailbox registers, a corresponding, new vendor-specific capability may be defined in accordance with the underlying interconnect protocol (e.g., PCIe or CXL). This new capability may utilize a vendor-specific extended capability (VSEC) register (e.g., in accordance with those devices in PCIe 5.0) to expose support of the capability by the XPU device to the host systems. FIGS. 9A-9C are example register structures illustrating an example by which the new capability can be added using PCIe vendor-specific extended capability. FIG. 9A illustrates an example PCIe VSEC capability structure 905 may be provided within configuration space of an XPU device within a system, which may be populated with values to identify to the host system (and system software) which (if any) vendor-specific (or otherwise non-natively specification-defined) capabilities are supported by the XPU device. In some examples, the VSEC capability structure 905 may be populated with one or more vendor specific registers (e.g., 910), as illustrated in FIG. 9B. Register fields of a vendor specific register 910 may include the identification of the next capability (e.g., within a linked list using offsets to identify the next capability structure), the capability version of the vendor-specific capability identified by the header 910, and an identifier corresponding to the vendor-specific capability. FIG. 9C illustrates an example vendor specific header 915. Based on the vendor-specific capability identifier, fields of the vendor specific header 915 may be interpreted, including the VSEC length field (e.g., used to indicate the number of total bytes in the entire, corresponding VSEC structure, including the vendor specific extended capability header, the vendor-specific header, and the vendor-specific register (which, in the case of executable-passing mailbox includes the mailbox register). The VSEC Rev field identifies the version of the VSEC structure, and the VSEC ID field identifies the nature and format of the VSEC structure, among other examples. Indeed, other protocols may utilize different capability structures and capability structure formats to identify support of a mailbox register capability to a host system, without departing from the principles discussed herein.

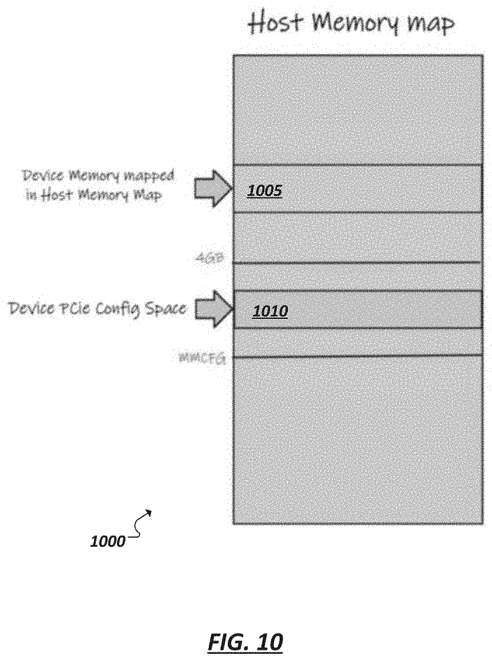

FIG. 10 is a simplified block diagram illustrating an example illustration of a memory map 1000 of a host device. A host device may be coupled to one or more multiple discrete devices, including XPU devices with processing hardware and corresponding functionality. The host may read capability registers of the various discrete devices during configuration of the corresponding system and links to identify the respective capabilities of each of the discrete devices, together with various registers or other data structures provided in memory of the discrete devices in connection with the supported capabilities. The host may identify device memory that is to be used for these structures and may map such device memory (at 1005) and device configuration space (at 1010) within the host's memory map. In cases where the discrete device is an XPU device and supports a mailbox register for the passing of executables, the support of this capability may be discovered by the host from the XPU device's capability register(s), together with the address (in the XPU device's memory) of the mailbox register to be accessed (e.g., read from and written to) by the host device.

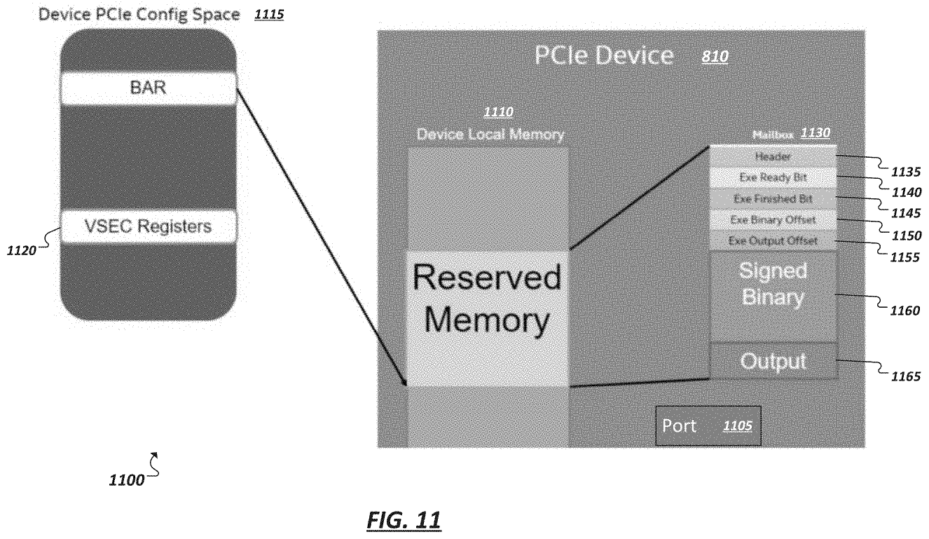

Turning to FIG. 11, a simplified block diagram 1100 is shown of a portion of an XPU device, such as an XPU device 810 compatible with a PCIe protocol. The XPU device 810 may include a port 1105 to coordinate with a port on a host system (not illustrated) and establish a PCIe link. The XPU device 810 may include device local memory 1110, which may be used to implement PCIe configuration space 1115 for the device 810. Within the configuration space 1115, a VSEC register 1120 may be implemented and identify that the XPU device 810 supports a mailbox communications capability to enable the passing of executables from the host device over the PCIe link. A BAR may identify a range of addresses within the local memory 1110 reserved to implement the mailbox 1130. In one example implementation, the mailbox 1130 is implemented as a register including a mailbox header field 1135, an execution ready field 1140, an execution finished field 1145, a binary executable offset field 1150, an execution output offset field 1155, and a field or range of addresses 1160 within the mailbox 1130 in which passed executable code is to be written (by the host device using PCIe write operations). Outputs of the executed code may be written to another field or range of addresses 1165 within the mailbox 1130.

In some implementations, the header field 1135 of an example mailbox 1130 may identify the beginning of the mailbox 1130 within memory 1110. Security requirements and policies may be defined that govern accesses to the XPU devices, as well as code that may be executed by the XPU device. Accordingly, in some implementations, security enhancements may be applied to data embodying executable code that is written to the mailbox. As one example, executable code may be signed, encrypted, or otherwise cryptographically secured. In some implementations, header 1135 may include information to identify whether and how executables written to the mailbox are to be protected. For instance, a key, hint, policy, or other information may be identified in the header 1135, among other example information that may be referred to or used by the host when writing executables to the mailbox 1130.

The mailbox may include fields (e.g., 1140, 1145) to identify when the XPU device is prepared to accept and execute new executables provided to the XPU from the host processor using the mailbox 1130. For instance, an executable ready field 1140 may be implemented as an executable ready bit. The executable ready bit may be written to by the host processor (e.g., using a corresponding PCIe write over the link coupling the host processor to the XPU device 810) to indicate to the XPU device 810 that a new executable has been written to the mailbox 1130 (at 1160). The XPU device 810 may read the executable from 1160 based on the executable ready field 1140 being written to. When the XPU device is finished executing the received executable, it may write to the execution finished bit 1165 to identify to the host device that the XPU device 810 is able to receive another executable from the host device through the mailbox 1130.

The field or region 1160 designated within the mailbox 1130 for the receipt of new executables may be sized to accept a variety of different executables (e.g., of different lengths). Accordingly, in some implementations, a host processor may identify where (e.g., what address) in the region 1160 the new executable code is written to within the region 1160. In such instances, a binary executable offset field 1150 may be written to by the host device to identify an offset value, address, or other value to identify the location of the newly written executable within the mailbox 1130. Similarly, an output field or region 1165 may be defined for use by the XPU device to write results or outputs from the execution of received executables. Outputs may also be of different lengths. In some implementations, the XPU device may write not only the outputs of the execution to the mailbox 1130, but also identify where in the output region 1165 the output data is written to writing a value to the execution output offset field 1155.

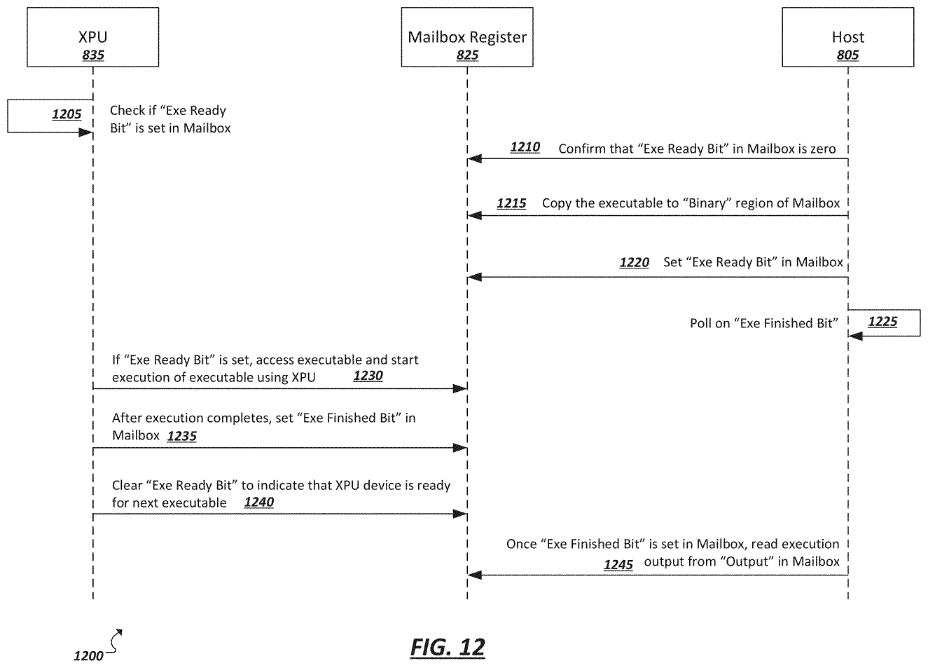

Turning to FIG. 12, a flow diagram 1200 is shown illustrating the example use of a mailbox register for the passing of executables from a host processor to an XPU device. For instance, mailbox management logic associated with an XPU 835 of an XPU device (e.g., a PCIe device with processor hardware), implemented for instance as XPU firmware, hardware circuitry logic of the XPU or another component of the XPU device, software, etc., may initialize a mailbox register 825 within local memory of the XPU firmware in accordance with a corresponding, advertised capability. The XPU 835 may then monitor the mailbox register 825 for the arrival of executables (e.g., binary executables) or other code received from a host device 805 using the mailbox register 825. In one example, a mailbox register 825 may be defined to include fields such as illustrated in the example of FIG. 11. In other example implementations, other or addition fields may be utilized to implement comparable mailbox register functionality. In the example of FIG. 12, the XPU 835 may poll or periodically check 1205 an execution ready field (“Exe Ready Bit”) in the mailbox register 825. The Exe Ready Bit may include a value (e.g., a binary bit) to indicate whether a new binary executable has been written to the mailbox register 825 for execution by the XPU 835. The Exe Ready Bit may be written to by the host device 805 (e.g., using a PCIe write over a PCIe link) in connection with or immediately following the host device writing a binary executable to a field or region within the mailbox 825 for the receipt of new executables.

In one example, the XPU 835 may check 1205 the Exe Ready Bit and identify that the Exe Ready Bit indicates that no new executable has been written to the mailbox register 825. The host device 805 may periodically read the Exe Ready Bit, as well, to identify if the Exe Ready Bit value has been reset (e.g., set to “0”) following the execution by the XPU 835 of the last executable written to the mailbox register 825. The host device 805 may identify (e.g., in connection with a larger program, application, or workload being handled by the host device) one or more executables that are to be executed by the XPU 835 in the program. In some instances, in order for an XPU device to execute executable code delivered to it, the XPU must authenticate the source and trustworthiness of the source. Accordingly, in some implementations, the host device 805 may sign or otherwise secure the next executable in accordance with policies of the XPU device (e.g., as may be identified within a header of the mailbox register (e.g., 825)). For instance, the executable may be encrypted or signed to identify that the host device 805 is trustworthy. In other cases, a token or other authentication data may be appended to the executable (when written to the mailbox 825), and the authentication data used by the XPU device to verify the trustworthiness of the delivered executable, among other examples.

Continuing with the example of FIG. 12, a host device 805 may read (e.g., using a PCIe read) the Exe Ready Bit to confirm 1210 that the Exe Ready Bit is “0” (to indicate that the mailbox 825 can receive a next executable). If the XPU 835 (and mailbox register 825) are ready to have the next executable written to the designated region of the mailbox register (e.g., based on the value of the Exe Ready Bit), the host device 805 may write 1215 the next executable (e.g., a signed executable) to the region and set 1220 (in the same or a subsequent write) the value of Exe Ready Bit to indicate that a new executable has been written to the mailbox register region. In some cases, the mailbox register 825 may include an offset field to identify to the XPU the precise location in the mailbox region, in which the new executable has been written. In other implementations, the mailbox register 825 may be configured such that new executables are always written to the same starting address, thereby negating the need for an offset value to be written to the mailbox in such implementations. After writing a new executable to the mailbox 825, the host device 805 may periodically read 1225 values of an execution finished field (“Exe Finished Bit”), which may include a bit to indicate whether the XPU 835 has executed the last written executable delivered to the mailbox 825.

From the perspective of the XPU 835, the XPU 835 may identify that the value of the Exe Ready Bit has flipped (e.g., from 0 to 1) to indicate that an executable has been newly written to the mailbox 825. Accordingly, the XPU 835 may access and start executing 1230 the executable. In instances where the executable is to be signed or otherwise secured to attest to the authenticity or trustworthiness of the executable (and its source (e.g., host device 805)), the XPU 835 may first assess the executable (e.g., analyze authentication data, decrypt the executable, validate a signature, etc.) to confirm that the executable is trustworthy and safe or permissible to execute. Execution of the executable may result in the generation of one or more outputs or results, which may be embodied as output data. The output data, in some implementations, may be stored, by the XPU, in another region of the mailbox register 825 designated for use in passing such outputs from the XPU 835 to the host 805 using the mailbox register 825. In some instances, an offset value may be written by the XPU 835 to identify where in the output region the output data has been written. In other instances, the mailbox may be defined such that output data is always written to the same location in the output region, such that the specification of an offset could be omitted.

After an XPU 835 finishes executing a received executable (and writing outputs of the execution to the mailbox 825), the XPU may indicate that it is complete by setting 1235 the Exe Finished Bit to identify that execution is complete. In association with completion of the execution, the XPU 835 may also clear 1240 the Exe Ready Bit (e.g., at the same time or separate from setting the Exe Finished Bit). As noted above, the Host device may poll 1225 the Exe Finished Bit to identify when the XPU 835 has finished execution of the latest provided executable. The setting of the Exe Finished Bit may also prompt the host device 805 to read 1245 the output region of the mailbox register 825 to identify and retrieve outputs generated by the XPU 835 through execution of the executable. The host device 805 may utilize the outputs in subsequent program steps (e.g., as an input to another instruction to be executed by the host device 805), among other examples. With the Exe Ready Bit cleared, the sequence may repeat, with the host device 805 identifying another executable to pass to the XPU 835 using the mailbox. Indeed, the host device 805 may orchestrate the passing of multiple different executables to multiple different XPU devices in a system in association with programs run on the system. Each of the XPU devices may have its own mailbox register, which is read and written to by the host device 805 in association with the passing of these executables, allowing execution of a program to be advantageously distributed among multiple different XPU devices in the system, among other examples.

Note that the apparatus', methods', and systems described above may be implemented in any electronic device or system as aforementioned. As specific illustrations, the figures below provide exemplary systems for utilizing the concepts as described herein, including implementations of host processor device and XPU devices as discussed herein. For instance, components illustrated in the following examples may be implemented on separate dies or packages, and may include logic (e.g., hardware and/or firmware) to support capabilities for passing executables to other processing devices via reads and writes to configured mailbox registers implemented on the devices, among other features discussed herein. As the systems below are described in more detail, a number of different interconnects are disclosed, described, and revisited from the discussion above. And as is readily apparent, the advances described above may be applied to any of those interconnects, fabrics, or architectures.

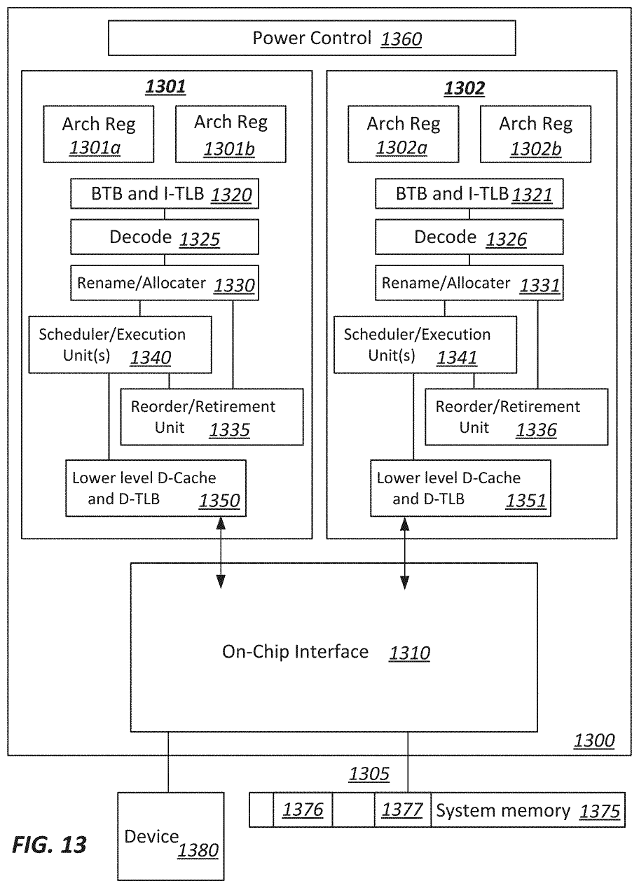

Referring to FIG. 13, an embodiment of a block diagram for a computing system including a multicore processor is depicted. Processor 1300 includes any processor or processing device, such as a microprocessor, an embedded processor, a digital signal processor (DSP), a network processor, a handheld processor, an application processor, a co-processor, a system on a chip (SOC), or other device to execute code. Processor 1300, in one embodiment, includes at least two cores—core 1301 and 1302, which may include asymmetric cores or symmetric cores (the illustrated embodiment). However, processor 1300 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core often refers to logic located on an integrated circuit capable of maintaining an independent architectural state, wherein each independently maintained architectural state is associated with at least some dedicated execution resources. In contrast to cores, a hardware thread typically refers to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical processor 1300, as illustrated in FIG. 13, includes two cores—core 1301 and 1302. Here, core 1301 and 1302 are considered symmetric cores, e.g. cores with the same configurations, functional units, and/or logic. In another embodiment, core 1301 includes an out-of-order processor core, while core 1302 includes an in-order processor core. However, cores 1301 and 1302 may be individually selected from any type of core, such as a native core, a software managed core, a core adapted to execute a native Instruction Set Architecture (ISA), a core adapted to execute a translated Instruction Set Architecture (ISA), a co-designed core, or other known core. In a heterogeneous core environment (e.g. asymmetric cores), some form of translation, such as a binary translation, may be utilized to schedule or execute code on one or both cores. Yet to further the discussion, the functional units illustrated in core 1301 are described in further detail below, as the units in core 1302 operate in a similar manner in the depicted embodiment.

As depicted, core 1301 includes two hardware threads 1301a and 1301b, which may also be referred to as hardware thread slots 1301a and 1301b. Therefore, software entities, such as an operating system, in one embodiment potentially view processor 1300 as four separate processors, e.g., four logical processors or processing elements capable of executing four software threads concurrently. As alluded to above, a first thread is associated with architecture state registers 1301a, a second thread is associated with architecture state registers 1301b, a third thread may be associated with architecture state registers 1302a, and a fourth thread may be associated with architecture state registers 1302b. Here, each of the architecture state registers (1301a, 1301b, 1302a, and 1302b) may be referred to as processing elements, thread slots, or thread units, as described above. As illustrated, architecture state registers 1301a are replicated in architecture state registers 1301b, so individual architecture states/contexts are capable of being stored for logical processor 1301a and logical processor 1301b. In core 1301, other smaller resources, such as instruction pointers and renaming logic in allocator and renamer block 1330 may also be replicated for threads 1301a and 1301b. Some resources, such as re-order buffers in reorder/retirement unit 1335, ILTB 1320, load/store buffers, and queues may be shared through partitioning. Other resources, such as general-purpose internal registers, page-table base register(s), low-level data-cache and data-TLB 1315, execution unit(s) 1340, and portions of out-of-order unit 1335 are potentially fully shared.

Processor 1300 often includes other resources, which may be fully shared, shared through partitioning, or dedicated by/to processing elements. In FIG. 13, an embodiment of a purely exemplary processor with illustrative logical units/resources of a processor is illustrated. Note that a processor may include, or omit, any of these functional units, as well as include any other known functional units, logic, or firmware not depicted. As illustrated, core 1301 includes a simplified, representative out-of-order (OOO) processor core. But an in-order processor may be utilized in different embodiments. The OOO core includes a branch target buffer 1320 to predict branches to be executed/taken and an instruction-translation buffer (I-TLB) 1320 to store address translation entries for instructions.

Core 1301 further includes decode module 1325 coupled to fetch unit 1320 to decode fetched elements. Fetch logic, in one embodiment, includes individual sequencers associated with thread slots 1301a, 1301b, respectively. Usually core 1301 is associated with a first ISA, which defines/specifies instructions executable on processor 1300. Often machine code instructions that are part of the first ISA include a portion of the instruction (referred to as an opcode), which references/specifies an instruction or operation to be performed. Decode logic 1325 includes circuitry that recognizes these instructions from their opcodes and passes the decoded instructions on in the pipeline for processing as defined by the first ISA. For example, as discussed in more detail below decoders 1325, in one embodiment, include logic designed or adapted to recognize specific instructions, such as transactional instruction. As a result of the recognition by decoders 1325, the architecture or core 1301 takes specific, predefined actions to perform tasks associated with the appropriate instruction. It is important to note that any of the tasks, blocks, operations, and methods described herein may be performed in response to a single or multiple instructions; some of which may be new or old instructions. Note decoders 1326, in one embodiment, recognize the same ISA (or a subset thereof). Alternatively, in a heterogeneous core environment, decoders 1326 recognize a second ISA (either a subset of the first ISA or a distinct ISA).

In one example, allocator and renamer block 1330 includes an allocator to reserve resources, such as register files to store instruction processing results. However, threads 1301a and 1301b are potentially capable of out-of-order execution, where allocator and renamer block 1330 also reserves other resources, such as reorder buffers to track instruction results. Unit 1330 may also include a register renamer to rename program/instruction reference registers to other registers internal to processor 1300. Reorder/retirement unit 1335 includes components, such as the reorder buffers mentioned above, load buffers, and store buffers, to support out-of-order execution and later in-order retirement of instructions executed out-of-order.

Scheduler and execution unit(s) block 1340, in one embodiment, includes a scheduler unit to schedule instructions/operation on execution units. For example, a floating point instruction is scheduled on a port of an execution unit that has an available floating point execution unit. Register files associated with the execution units are also included to store information instruction processing results. Exemplary execution units include a floating point execution unit, an integer execution unit, a jump execution unit, a load execution unit, a store execution unit, and other known execution units.

Lower level data cache and data translation buffer (D-TLB) 1350 are coupled to execution unit(s) 1340. The data cache is to store recently used/operated on elements, such as data operands, which are potentially held in memory coherency states. The D-TLB is to store recent virtual/linear to physical address translations. As a specific example, a processor may include a page table structure to break physical memory into a plurality of virtual pages.

Here, cores 1301 and 1302 share access to higher-level or further-out cache, such as a second level cache associated with on-chip interface 1310. Note that higher-level or further-out refers to cache levels increasing or getting further way from the execution unit(s). In one embodiment, higher-level cache is a last-level data cache—last cache in the memory hierarchy on processor 1300—such as a second or third level data cache. However, higher level cache is not so limited, as it may be associated with or include an instruction cache. A trace cache—a type of instruction cache—instead may be coupled after decoder 1325 to store recently decoded traces. Here, an instruction potentially refers to a macro-instruction (e.g. a general instruction recognized by the decoders), which may decode into a number of micro-instructions (micro-operations).

In the depicted configuration, processor 1300 also includes on-chip interface module 1310. Historically, a memory controller, which is described in more detail below, has been included in a computing system external to processor 1300. In this scenario, on-chip interface 1310 is to communicate with devices external to processor 1300, such as system memory 1375, a chipset (often including a memory controller hub to connect to memory 1375 and an I/O controller hub to connect peripheral devices), a memory controller hub, a northbridge, or other integrated circuit. And in this scenario, bus 1305 may include any known interconnect, such as multi-drop bus, a point-to-point interconnect, a serial interconnect, a parallel bus, a coherent (e.g. cache coherent) bus, a layered protocol architecture, a differential bus, and a GTL bus.

Memory 1375 may be dedicated to processor 1300 or shared with other devices in a system. Common examples of types of memory 1375 include DRAM, SRAM, non-volatile memory (NV memory), and other known storage devices. Note that device 1380 may include a graphic accelerator, processor or card coupled to a memory controller hub, data storage coupled to an I/O controller hub, a wireless transceiver, a flash device, an audio controller, a network controller, or other known device.

Recently however, as more logic and devices are being integrated on a single die, such as SOC, each of these devices may be incorporated on processor 1300. For example, in one embodiment, a memory controller hub is on the same package and/or die with processor 1300. Here, a portion of the core (an on-core portion) 1310 includes one or more controller(s) for interfacing with other devices such as memory 1375 or a graphics device 1380. The configuration including an interconnect and controllers for interfacing with such devices is often referred to as an on-core (or un-core configuration). As an example, on-chip interface 1310 includes a ring interconnect for on-chip communication and a high-speed serial point-to-point link 1305 for off-chip communication. Yet, in the SOC environment, even more devices, such as the network interface, co-processors, memory 1375, graphics processor 1380, and any other known computer devices/interface may be integrated on a single die or integrated circuit to provide small form factor with high functionality and low power consumption.

In one embodiment, processor 1300 is capable of executing a compiler, optimization, and/or translator code 1377 to compile, translate, and/or optimize application code 1376 to support the apparatus and methods described herein or to interface therewith. A compiler often includes a program or set of programs to translate source text/code into target text/code. Usually, compilation of program/application code with a compiler is done in multiple phases and passes to transform hi-level programming language code into low-level machine or assembly language code. Yet, single pass compilers may still be utilized for simple compilation. A compiler may utilize any known compilation techniques and perform any known compiler operations, such as lexical analysis, preprocessing, parsing, semantic analysis, code generation, code transformation, and code optimization.

Larger compilers often include multiple phases, but most often these phases are included within two general phases: (1) a front-end, e.g. generally where syntactic processing, semantic processing, and some transformation/optimization may take place, and (2) a back-end, e.g. generally where analysis, transformations, optimizations, and code generation takes place. Some compilers refer to a middle, which illustrates the blurring of delineation between a front-end and back end of a compiler. As a result, reference to insertion, association, generation, or other operation of a compiler may take place in any of the aforementioned phases or passes, as well as any other known phases or passes of a compiler. As an illustrative example, a compiler potentially inserts operations, calls, functions, etc. in one or more phases of compilation, such as insertion of calls/operations in a front-end phase of compilation and then transformation of the calls/operations into lower-level code during a transformation phase. Note that during dynamic compilation, compiler code or dynamic optimization code may insert such operations/calls, as well as optimize the code for execution during runtime. As a specific illustrative example, binary code (already compiled code) may be dynamically optimized during runtime. Here, the program code may include the dynamic optimization code, the binary code, or a combination thereof.

Similar to a compiler, a translator, such as a binary translator, translates code either statically or dynamically to optimize and/or translate code. Therefore, reference to execution of code, application code, program code, or other software environment may refer to: (1) execution of a compiler program(s), optimization code optimizer, or translator either dynamically or statically, to compile program code, to maintain software structures, to perform other operations, to optimize code, or to translate code; (2) execution of main program code including operations/calls, such as application code that has been optimized/compiled; (3) execution of other program code, such as libraries, associated with the main program code to maintain software structures, to perform other software related operations, or to optimize code; or (4) a combination thereof.

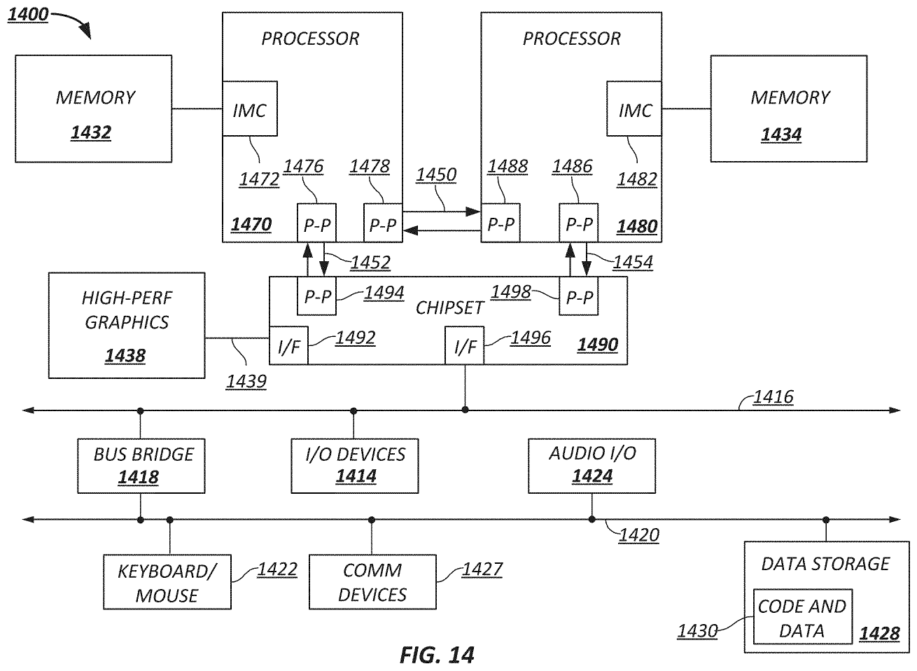

Referring now to FIG. 14, shown is a block diagram of a second system 1400 in accordance with an embodiment of the present solutions. As shown in FIG. 14, multiprocessor system 1400 is a point-to-point interconnect system, and includes a first processor 1470 and a second processor 1480 coupled via a point-to-point interconnect 1450. Each of processors 1470 and 1480 may be some version of a processor. In one embodiment, 1452 and 1454 are part of a serial, point-to-point coherent (or non-coherent) interconnect fabric.

While shown with only two processors 1470, 1480, it is to be understood that the scope of the present disclosure is not so limited. In other embodiments, one or more additional processors may be present in a given processor.

Processors 1470 and 1480 are shown including integrated memory controller units 1472 and 1482, respectively. Processor 1470 also includes as part of its bus controller units point-to-point (P-P) interfaces 1476 and 1478; similarly, second processor 1480 includes P-P interfaces 1486 and 1488. Processors 1470, 1480 may exchange information via a point-to-point (P-P) interface 1450 using P-P interface circuits 1478, 1488. As shown in FIG. 14, IMCs 1472 and 1482 couple the processors to respective memories, namely a memory 1432 and a memory 1434, which may be portions of main memory locally attached to the respective processors.

Processors 1470, 1480 each exchange information with a chipset 1490 via individual P-P interfaces 1452, 1454 using point to point interface circuits 1476, 1494, 1486, 1498. Chipset 1490 also exchanges information with a high-performance graphics circuit 1438 via an interface circuit 1492 along a high-performance graphics interconnect 1439.

A shared cache (not shown) may be included in either processor or outside of both processors; yet connected with the processors via P-P interconnect, such that either or both processors' local cache information may be stored in the shared cache if a processor is placed into a low power mode.

Chipset 1490 may be coupled to a first bus 1416 via an interface 1496. In one embodiment, first bus 1416 may be a Peripheral Component Interconnect (PCI) bus, or a bus such as a PCI Express bus or another third generation I/O interconnect bus, although the scope of the present disclosure is not so limited.

As shown in FIG. 14, various I/O devices 1414 are coupled to first bus 1416, along with a bus bridge 1418 which couples first bus 1416 to a second bus 1420. In one embodiment, second bus 1420 includes a low pin count (LPC) bus. Various devices are coupled to second bus 1420 including, for example, a keyboard and/or mouse 1422, communication devices 1427 and a storage unit 1428 such as a disk drive or other mass storage device which often includes instructions/code and data 1430, in one embodiment. Further, an audio I/O 1424 is shown coupled to second bus 1420. Note that other architectures are possible, where the included components and interconnect architectures vary. For example, instead of the point-to-point architecture of FIG. 14, a system may implement a multi-drop bus or other such architecture.

Computing systems can include various combinations of components. These components may be implemented as ICs, portions thereof, discrete electronic devices, or other modules, logic, hardware, software, firmware, or a combination thereof adapted in a computer system, or as components otherwise incorporated within a chassis of the computer system. However, it is to be understood that some of the components shown may be omitted, additional components may be present, and different arrangement of the components shown may occur in other implementations. As a result, the features and components described above may be implemented in any portion of one or more of the interconnects illustrated or described below.

A processor, in one embodiment, includes a microprocessor, multi-core processor, multithreaded processor, an ultra-low voltage processor, an embedded processor, or other known processing element. In the illustrated implementation, processor acts as a main processing unit and central hub for communication with many of the various components of the system. As one example, processor is implemented as a system on a chip (SoC). As a specific illustrative example, processor includes an Intel® Architecture Core™-based processor such as an i3, i5, i7 or another such processor available from Intel Corporation, Santa Clara, Calif. However, understand that other low power processors such as available from Advanced Micro Devices, Inc. (AMD) of Sunnyvale, Calif., a MIPS-based design from MIPS Technologies, Inc. of Sunnyvale, Calif., an ARM-based design licensed from ARM Holdings, Ltd. or customer thereof, or their licensees or adopters may instead be present in other embodiments such as an Apple A5/A6 processor, a Qualcomm Snapdragon processor, or TI OMAP processor. Note that many of the customer versions of such processors are modified and varied; however, they may support or recognize a specific instruction set that performs defined algorithms as set forth by the processor licensor. Here, the microarchitectural implementation may vary, but the architectural function of the processor is usually consistent. Certain details regarding the architecture and operation of processor in one implementation will be discussed further below to provide an illustrative example.

Processor, in one embodiment, communicates with a system memory. As an illustrative example, which in an embodiment can be implemented via multiple memory devices to provide for a given amount of system memory. As examples, the memory can be in accordance with a Joint Electron Devices Engineering Council (JEDEC) low power double data rate (LPDDR)-based design such as the current LPDDR2 standard according to JEDEC JESD 209-2E (published April 2009), or a next generation LPDDR standard to be referred to as LPDDR3 or LPDDR4 that will offer extensions to LPDDR2 to increase bandwidth. In various implementations the individual memory devices may be of different package types such as single die package (SDP), dual die package (DDP) or quad die package (13P). These devices, in some embodiments, are directly soldered onto a motherboard to provide a lower profile solution, while in other embodiments the devices are configured as one or more memory modules that in turn couple to the motherboard by a given connector. And of course, other memory implementations are possible such as other types of memory modules, e.g., dual inline memory modules (DIMMs) of different varieties including but not limited to microDIMMs, MiniDIMMs. In a particular illustrative embodiment, memory is sized between 2 GB and 16 GB, and may be configured as a DDR3LM package or an LPDDR2 or LPDDR3 memory that is soldered onto a motherboard via a ball grid array (BGA).

To provide for persistent storage of information such as data, applications, one or more operating systems and so forth, a mass storage may also couple to processor. In various embodiments, to enable a thinner and lighter system design as well as to improve system responsiveness, this mass storage may be implemented via an SSD. However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. A flash device may be coupled to processor, e.g., via a serial peripheral interface (SPI). This flash device may provide for non-volatile storage of system software, including a basic input/output software (BIOS) as well as other firmware of the system.

In various embodiments, mass storage of the system is implemented by an SSD alone or as a disk, optical or other drive with an SSD cache. In some embodiments, the mass storage is implemented as an SSD or as an HDD along with a restore (RST) cache module. In various implementations, the HDD provides for storage of between 320 GB-4 terabytes (TB) and upward while the RST cache is implemented with an SSD having a capacity of 24 GB-256 GB. Note that such SSD cache may be configured as a single level cache (SLC) or multi-level cache (MLC) option to provide an appropriate level of responsiveness. In an SSD-only option, the module may be accommodated in various locations such as in a mSATA or NGFF slot. As an example, an SSD has a capacity ranging from 120 GB-1TB.

Various peripheral devices may couple to processor via a low pin count (LPC) interconnect. In the embodiment shown, various components can be coupled through an embedded controller. Such components can include a keyboard (e.g., coupled via a PS2 interface), a fan, and a thermal sensor. In some embodiments, touch pad may also couple to EC via a PS2 interface. In addition, a security processor such as a trusted platform module (TPM) in accordance with the Trusted Computing Group (TCG) TPM Specification Version 1.2, dated Oct. 2, 2003, may also couple to processor via this LPC interconnect. However, understand the scope of the present disclosure is not limited in this regard and secure processing and storage of secure information may be in another protected location such as a static random access memory (SRAM) in a security coprocessor, or as encrypted data blobs that are only decrypted when protected by a secure enclave (SE) processor mode.

In a particular implementation, peripheral ports may include a high definition media interface (HDMI) connector (which can be of different form factors such as full size, mini or micro); one or more USB ports, such as full-size external ports in accordance with the Universal Serial Bus Revision 3.0 Specification (November 2008), with at least one powered for charging of USB devices (such as smartphones) when the system is in Connected Standby state and is plugged into AC wall power. In addition, one or more Thunderbolt™ ports can be provided. Other ports may include an externally accessible card reader such as a full-size SD-XC card reader and/or a SIM card reader for WWAN (e.g., an 8-pin card reader). For audio, a 3.5 mm jack with stereo sound and microphone capability (e.g., combination functionality) can be present, with support for jack detection (e.g., headphone only support using microphone in the lid or headphone with microphone in cable). In some embodiments, this jack can be re-taskable between stereo headphone and stereo microphone input. Also, a power jack can be provided for coupling to an AC brick.

System can communicate with external devices in a variety of manners, including wirelessly. In some instances, various wireless modules, each of which can correspond to a radio configured for a particular wireless communication protocol, are present. One manner for wireless communication in a short range such as a near field may be via a near field communication (NFC) unit which may communicate, in one embodiment with processor via an SMBus. Note that via this NFC unit, devices in close proximity to each other can communicate. For example, a user can enable system to communicate with another (e.g.,) portable device such as a smartphone of the user via adapting the two devices together in close relation and enabling transfer of information such as identification information payment information, data such as image data or so forth. Wireless power transfer may also be performed using an NFC system.

Using the NFC unit described herein, users can bump devices side-to-side and place devices side-by-side for near field coupling functions (such as near field communication and wireless power transfer (WPT)) by leveraging the coupling between coils of one or more of such devices. More specifically, embodiments provide devices with strategically shaped, and placed, ferrite materials, to provide for better coupling of the coils. Each coil has an inductance associated with it, which can be chosen in conjunction with the resistive, capacitive, and other features of the system to enable a common resonant frequency for the system.

Further, additional wireless units can include other short-range wireless engines including a WLAN unit and a Bluetooth unit. Using WLAN unit, Wi-Fi™ communications in accordance with a given Institute of Electrical and Electronics Engineers (IEEE) 802.11 standard can be realized, while via Bluetooth unit, short range communications via a Bluetooth protocol can occur. These units may communicate with processor via, e.g., a USB link or a universal asynchronous receiver transmitter (UART) link. Or these units may couple to processor via an interconnect according to a Peripheral Component Interconnect Express™ (PCIe™) protocol, e.g., in accordance with the PCI Express™ Specification Base Specification version 3.0 (published Jan. 17, 2007), or another such protocol such as a serial data input/output (SDIO) standard. Of course, the actual physical connection between these peripheral devices, which may be configured on one or more add-in cards, can be by way of the NGFF connectors adapted to a motherboard.

In addition, wireless wide area communications, e.g., according to a cellular or other wireless wide area protocol, can occur via a WWAN unit which in turn may couple to a subscriber identity module (SIM). In addition, to enable receipt and use of location information, a GPS module may also be present. WWAN unit and an integrated capture device such as a camera module may communicate via a given USB protocol such as a USB 2.0 or 3.0 link, or a UART or I²C protocol. Again, the actual physical connection of these units can be via adaptation of a NGFF add-in card to an NGFF connector configured on the motherboard.

In a particular embodiment, wireless functionality can be provided modularly, e.g., with a WiFi™ 802.11ac solution (e.g., add-in card that is backward compatible with IEEE 802.11abgn) with support for Windows 8 CS. This card can be configured in an internal slot (e.g., via an NGFF adapter). An additional module may provide for Bluetooth capability (e.g., Bluetooth 4.0 with backwards compatibility) as well as Intel® Wireless Display functionality. In addition, NFC support may be provided via a separate device or multi-function device, and can be positioned as an example, in a front right portion of the chassis for easy access. A still additional module may be a WWAN device that can provide support for 3G/4G/LTE and GPS. This module can be implemented in an internal (e.g., NGFF) slot. Integrated antenna support can be provided for WiFi™, Bluetooth, WWAN, NFC and GPS, enabling seamless transition from WiFi™ to WWAN radios, wireless gigabit (WiGig) in accordance with the Wireless Gigabit Specification (July 2010), and vice versa.

As described above, an integrated camera can be incorporated in the lid. As one example, this camera can be a high-resolution camera, e.g., having a resolution of at least 2.0 megapixels (MP) and extending to 6.0 MP and beyond.

To provide for audio inputs and outputs, an audio processor can be implemented via a digital signal processor (DSP), which may couple to processor via a high definition audio (HDA) link. Similarly, DSP may communicate with an integrated coder/decoder (CODEC) and amplifier that in turn may couple to output speakers which may be implemented within the chassis. Similarly, amplifier and CODEC can be coupled to receive audio inputs from a microphone which in an embodiment can be implemented via dual array microphones (such as a digital microphone array) to provide for high quality audio inputs to enable voice-activated control of various operations within the system. Note also that audio outputs can be provided from amplifier/CODEC to a headphone jack.

In a particular embodiment, the digital audio codec and amplifier are capable of driving the stereo headphone jack, stereo microphone jack, an internal microphone array and stereo speakers. In different implementations, the codec can be integrated into an audio DSP or coupled via an HD audio path to a peripheral controller hub (PCH). In some implementations, in addition to integrated stereo speakers, one or more bass speakers can be provided, and the speaker solution can support DTS audio.

In some embodiments, processor may be powered by an external voltage regulator (VR) and multiple internal voltage regulators that are integrated inside the processor die, referred to as fully integrated voltage regulators (FIVRs). The use of multiple FIVRs in the processor enables the grouping of components into separate power planes, such that power is regulated and supplied by the FIVR to only those components in the group. During power management, a given power plane of one FIVR may be powered down or off when the processor is placed into a certain low power state, while another power plane of another FIVR remains active, or fully powered.

In one embodiment, a sustain power plane can be used during some deep sleep states to power on the I/O pins for several I/O signals, such as the interface between the processor and a PCH, the interface with the external VR and the interface with EC. This sustain power plane also powers an on-die voltage regulator that supports the on-board SRAM or other cache memory in which the processor context is stored during the sleep state. The sustain power plane is also used to power on the processor's wakeup logic that monitors and processes the various wakeup source signals.

During power management, while other power planes are powered down or off when the processor enters certain deep sleep states, the sustain power plane remains powered on to support the above-referenced components. However, this can lead to unnecessary power consumption or dissipation when those components are not needed. To this end, embodiments may provide a connected standby sleep state to maintain processor context using a dedicated power plane. In one embodiment, the connected standby sleep state facilitates processor wakeup using resources of a PCH which itself may be present in a package with the processor. In one embodiment, the connected standby sleep state facilitates sustaining processor architectural functions in the PCH until processor wakeup, this enabling turning off all of the unnecessary processor components that were previously left powered on during deep sleep states, including turning off all of the clocks. In one embodiment, the PCH contains a time stamp counter (TSC) and connected standby logic for controlling the system during the connected standby state. The integrated voltage regulator for the sustain power plane may reside on the PCH as well.

In an embodiment, during the connected standby state, an integrated voltage regulator may function as a dedicated power plane that remains powered on to support the dedicated cache memory in which the processor context is stored such as critical state variables when the processor enters the deep sleep states and connected standby state. This critical state may include state variables associated with the architectural, micro-architectural, debug state, and/or similar state variables associated with the processor.

The wakeup source signals from EC may be sent to the PCH instead of the processor during the connected standby state so that the PCH can manage the wakeup processing instead of the processor. In addition, the TSC is maintained in the PCH to facilitate sustaining processor architectural functions.

Power control in the processor can lead to enhanced power savings. For example, power can be dynamically allocated between cores, individual cores can change frequency/voltage, and multiple deep low power states can be provided to enable very low power consumption. In addition, dynamic control of the cores or independent core portions can provide for reduced power consumption by powering off components when they are not being used.

In different implementations, a security module such as a TPM can be integrated into a processor or can be a discrete device such as a TPM 2.0 device. With an integrated security module, also referred to as Platform Trust Technology (PTT), BIOS/firmware can be enabled to expose certain hardware features for certain security features, including secure instructions, secure boot, Intel® Anti-Theft Technology, Intel® Identity Protection Technology, Intel® Trusted Execution Technology (TXT), and Intel® Manageability Engine Technology along with secure user interfaces such as a secure keyboard and display.

While the above solutions have been described with respect to a limited number of embodiments, those skilled in the art will appreciate numerous modifications and variations therefrom. It is intended that the appended claims cover all such modifications and variations as fall within the true spirit and scope of this present disclosure.

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. A memory or a magnetic or optical storage such as a disc may be the machine-readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example, the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, e.g. reset, while an updated value potentially includes a low logical value, e.g. set. Note that any combination of values may be utilized to represent any number of states.

The following examples pertain to embodiments in accordance with this Specification. Example 1 is an apparatus including: processor circuitry; a memory; a port to couple to a host processor device via an interconnect; and a mailbox manager to: determine that a ready value in a mailbox register identifies that a first executable is written to a particular location in the mailbox register, where the mailbox register is implemented in the memory, and the first executable is written to the mailbox register by the host processor; read the first executable from the particular location in the mailbox register, where the processor circuitry is to execute the first executable to generate a result; and write an execution finished value to the mailbox register based on execution of the executable by the processor circuitry.

Example 2 includes the subject matter of example 1, where the mailbox register includes a ready value field for the ready value, an execution finished value field for the execution finished value, and a received executables region, where the received executables region includes the particular location.

Example 3 includes the subject matter of example 2, where the mailbox manager is to: write a result value associated with the result to an output region of the mailbox.

Example 4 includes the subject matter of example 3, where the mailbox register further includes an executable offset field to identify where executables are written within the received executables region, and an output offset field to identify where results are written within the output region.

Example 5 includes the subject matter of any one of examples 1-4, where the mailbox manager is implemented in firmware.

Example 6 includes the subject matter of any one of examples 1-5, where the mailbox manager is implemented in hardware circuitry.

Example 7 includes the subject matter of any one of examples 1-6, where the first executable includes a portion of a program, and another portion of the program includes a second executable to be executed by the host processor device.

Example 8 includes the subject matter of any one of examples 1-7, further including a capability register to identify to the host processor device that a vendor-defined capability is supported associated with use of mailbox registers to accept executables from the host processor device.

Example 9 includes the subject matter of example 8, where the vendor-defined capability includes a vendor specific capability according to a Peripheral Component Interconnect Express (PCIe)-based protocol.

Example 10 includes the subject matter of any one of examples 1-9, where the first executable includes security data to indicate trustworthiness of the first executable, and the mailbox manager is to verify trustworthiness of the first executable prior to allowing the processor circuity to execute the first executable.

Example 11 includes the subject matter of example 10, where the security data includes a digital signature.

Example 12 includes the subject matter of any one of examples 10-11, where the mailbox register includes a header to identify the mailbox register in the memory and identify a security policy for the mailbox register, where the security data is based on the security policy.

Example 13 includes the subject matter of any one of examples 1-12, where the interconnect is compliant with a PCIe-based protocol, and the host processor device is to read from and write to the mailbox register based on the PCIe-based protocol.

Example 14 includes the subject matter of any one of examples 1-12, where the interconnect is compliant with a Compute Express Link (CXL)-based protocol, and the host processor device is to read from and write to the mailbox register based on the CXL-based protocol.

Example 15 includes the subject matter of any one of examples 1-14, where the processor circuitry includes one of a graphics processing unit (GPU), network processing unit (NPU), tensor processing unit (TPU), infrastructure processing unit (IPU), or hardware accelerator.

Example 16 is a method including: sending one or more first write requests, from a host processor to a processor device over an interconnect, to: write a first binary executable to a mailbox register of the processor device, where the mailbox register is in local memory of the processor device, and the first binary executable includes a portion of a program; and write a value to an executable ready field in the mailbox register corresponding to writing the first binary executable to the mailbox register; sending one or more first read request, from the host processor to the processor device over the interconnect, to: identify from a value in an execution complete field of the mailbox register that the processor device completed execution of the first binary executable; and access result data from a results region of the mailbox register, where the result data includes a result generated by the processor device from completed execution of the first binary executable; and using the result data, at the host processor, in association with a second portion of the program executed using the host processor.

Example 17 includes the subject matter of example 16, further including: determining from a value in a ready bit of the mailbox register that the processor device is ready to accept another executable at the mailbox register; and sending one or more second write requests, from the host processor to the processor device over the interconnect, to write a different second binary executable to the mailbox register of the processor device, where the processor device is to execute the second binary executable.

Example 18 includes the subject matter of example 16, further including: sending one or more second write requests, from the host processor to a second processor device over a second interconnect, to: write a second binary executable to a mailbox register in local memory of the second processor device; sending one or more first write requests, from a host processor to a processor device over an interconnect, to: write a first binary executable to a mailbox register of the processor device, where the mailbox register is in local memory of the processor device, and the first binary executable includes a portion of a program; and write a value to an executable ready field in the mailbox register of the second processor device corresponding to writing the second binary executable to the mailbox register of the second processor device; and sending one or more second read requests, from the host processor to the second processor device over the second interconnect, to: identify from a value in an execution complete field of the mailbox register of the second processor device that the second processor device completed execution of the second binary executable; and access second result data from a results region of the mailbox register of the second processor device, where the second result data includes a result generated by the second processor device from completed execution of the second binary executable.

Example 19 includes the subject matter of any one of examples 16-18, further including: determining a security policy associated with the first processor device; generating trust data associated with the first binary executable based on the security policy; and writing the trust data in the mailbox register to identify to the first processor device that the first binary executable is from a trusted source.

Example 20 includes the subject matter of example 19, where the trust data includes a digital signature and is written with the first binary executable to form a signed first binary executable.

Example 21 includes the subject matter of any one of examples 19-20, where the mailbox register includes a header and the security policy is determined from one or more fields of the header.

Example 22 includes the subject matter of any one of examples 16-21, further including: reading a capability register in configuration space of the first processor device to identify to that the first processor device supports a vendor-defined capability associated with use of mailbox registers to accept executables from the host processor device.

Example 23 includes the subject matter of example 22, where the vendor-defined capability includes a vendor specific capability according to a Peripheral Component Interconnect Express (PCIe)-based protocol.

Example 24 includes the subject matter of any one of examples 16-23, where the interconnect is compliant with a PCIe-based protocol, and the host processor device is to read from and write to the mailbox register based on the PCIe-based protocol.

Example 25 includes the subject matter of any one of examples 16-23, where the interconnect is compliant with a Compute Express Link (CXL)-based protocol, and the host processor device is to read from and write to the mailbox register based on the CXL-based protocol.

Example 26 includes the subject matter of any one of examples 16-23, where the first processor device includes one of a graphics processing unit (GPU), network processing unit (NPU), tensor processing unit (TPU), infrastructure processing unit (IPU), or hardware accelerator.

Example 27 is a system including means to perform the method of any one of examples 16-26.

Example 28 is a system including: a host processor device; a first processor device coupled to the host processor device by an interconnect, the first processor device including: processor circuitry; a local memory; a mailbox manager to: determine that a ready value in a mailbox register identifies that a first executable is written to a particular location in the mailbox register, where the mailbox register is implemented in the local memory, and the first executable is written to the mailbox register by the host processor device; read the first executable from the particular location in the mailbox register, where the processor circuitry is to execute the first executable to generate a result; and write an execution finished value to the mailbox register based on execution of the executable by the processor circuitry.

Example 29 includes the subject matter of example 28, where first executable includes a first portion of an application, the host processor device includes circuitry to: access the mailbox register over the interconnect to read a result value posted in the mailbox register by the first processor device based on execution of the first executable; and use the result value in association with execution of a second portion of the application by the host processor device.

Example 30 includes the subject matter of example 28, where the mailbox register includes: a header to identify the mailbox register in the local memory and identify attributes of the mailbox register; a ready value field for the ready value; an execution finished value field for the execution finished value; a received executables region to receive executables, where the received executables region includes the particular location; an executable offset field to identify where executables are written within the received executables region; a results region to receive the results value; and an output offset field to identify where results are written within the results region.

Example 31 includes the subject matter of any one of examples 28-30, further including a second processor device coupled to the host processor device by a second interconnect, where the second processor device includes a second mailbox register to accept executables from the host processor device over the second interconnect.

Example 32 includes the subject matter of any one of examples 28-31, where the host processor device includes a host central processing unit (CPU), and the processor circuitry of the processor device includes a different type of processing unit.

Example 33 includes the subject matter of example 32, where the processor device includes one of a graphics processing unit (GPU), network processing unit (NPU), tensor processing unit (TPU), infrastructure processing unit (IPU), or hardware accelerator.

Example 34 includes the subject matter of any one of examples 28-33, where interconnect is compliant with a particular interconnect protocol, and the host processor device is to access the mailbox register according to the particular interconnect protocol.

Example 35 includes the subject matter of any one of examples 28-34, where the particular interconnect protocol includes one of Peripheral Component Interconnect Express (PCIe) or Compute Express Link (CXL).

Example 36 includes the subject matter of any one of examples 28-35, where the processor device includes a capability register to identify to the host processor device that a vendor-defined capability is supported associated with use of mailbox registers to accept executables from the host processor device.

Example 37 includes the subject matter of example 368, where the vendor-defined capability includes a vendor specific capability according to a Peripheral Component Interconnect Express (PCIe)-based protocol.

Example 38 includes the subject matter of any one of examples 28-37, where the first executable includes security data to indicate trustworthiness of the first executable, and the mailbox manager is to verify trustworthiness of the first executable prior to allowing the processor circuity to execute the first executable.

Example 39 includes the subject matter of example 38, where the security data includes a digital signature.

Example 40 includes the subject matter of any one of examples 38-39, where the mailbox register includes a header to identify the mailbox register in the memory and identify a security policy for the mailbox register, where the security data is based on the security policy.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (e.g., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the invention as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. An apparatus comprising:
processor circuitry;
a memory;
a port to couple to a host processor device via an interconnect;
a mailbox manager to:
determine that a ready value in a mailbox register identifies that a first executable is written to a particular location in the mailbox register, wherein the mailbox register is implemented in the memory, and the first executable is written to the mailbox register by the host processor;
read the first executable from the particular location in the mailbox register, wherein the processor circuitry is to execute the first executable to generate a result; and
write an execution finished value to the mailbox register based on execution of the executable by the processor circuitry.

2. The apparatus of claim 1, wherein the mailbox register comprises a ready value field for the ready value, an execution finished value field for the execution finished value, and a received executables region, wherein the received executables region comprises the particular location.

3. The apparatus of claim 2, wherein the mailbox manager is to:
write a result value associated with the result to an output region of the mailbox.

4. The apparatus of claim 3, wherein the mailbox register further comprises an executable offset field to identify where executables are written within the received executables region, and an output offset field to identify where results are written within the output region.

5. The apparatus of claim 1, wherein the mailbox manager is implemented in firmware.

6. The apparatus of claim 1, wherein the mailbox manager is implemented in hardware circuitry.

7. The apparatus of claim 1, wherein the first executable comprises a portion of a program, and another portion of the program comprises a second executable to be executed by the host processor device.

8. The apparatus of claim 1, further comprising a capability register to identify to the host processor device that a vendor-defined capability is supported associated with use of mailbox registers to accept executables from the host processor device.

9. The apparatus of claim 8, wherein the vendor-defined capability comprises a vendor specific capability according to a Peripheral Component Interconnect Express (PCIe)-based protocol.

10. The apparatus of claim 1, wherein the first executable comprises security data to indicate trustworthiness of the first executable, and the mailbox manager is to verify trustworthiness of the first executable prior to allowing the processor circuity to execute the first executable.

11. The apparatus of claim 10, wherein the security data comprises a digital signature.

12. The apparatus of claim 10, wherein the mailbox register comprises a header to identify the mailbox register in the memory and identify a security policy for the mailbox register, wherein the security data is based on the security policy.

13. The apparatus of claim 1, wherein the interconnect is compliant with a PCIe-based protocol, and the host processor device is to read from and write to the mailbox register based on the PCIe-based protocol.

14. The apparatus of claim 1, wherein the interconnect is compliant with a Compute Express Link (CXL)-based protocol, and the host processor device is to read from and write to the mailbox register based on the CXL-based protocol.

15. The apparatus of claim 1, wherein the processor circuitry comprises one of a graphics processing unit (GPU), network processing unit (NPU), tensor processing unit (TPU), infrastructure processing unit (IPU), or hardware accelerator.

16. A method comprising:
sending one or more first write requests, from a host processor to a processor device over an interconnect, to:
write a first binary executable to a mailbox register of the processor device, wherein the mailbox register is in local memory of the processor device, and the first binary executable comprises a portion of a program; and
write a value to an executable ready field in the mailbox register corresponding to writing the first binary executable to the mailbox register;
sending one or more first read request, from the host processor to the processor device over the interconnect, to:
identify from a value in an execution complete field of the mailbox register that the processor device completed execution of the first binary executable; and
access result data from a results region of the mailbox register, wherein the result data comprises a result generated by the processor device from completed execution of the first binary executable; and
using the result data, at the host processor, in association with a second portion of the program executed using the host processor.

17. The method of claim 16, further comprising:
determining from a value in a ready bit of the mailbox register that the processor device is ready to accept another executable at the mailbox register;
sending one or more second write requests, from the host processor to the processor device over the interconnect, to write a different second binary executable to the mailbox register of the processor device, wherein the processor device is to execute the second binary executable.

18. The method of claim 16, further comprising:
sending one or more second write requests, from the host processor to a second processor device over a second interconnect, to:
write a second binary executable to a mailbox register in local memory of the second processor device; sending one or more first write requests, from a host processor to a processor device over an interconnect, to:
write a first binary executable to a mailbox register of the processor device, wherein the mailbox register is in local memory of the processor device, and the first binary executable comprises a portion of a program; and
write a value to an executable ready field in the mailbox register of the second processor device corresponding to writing the second binary executable to the mailbox register of the second processor device;
sending one or more second read requests, from the host processor to the second processor device over the second interconnect, to:
identify from a value in an execution complete field of the mailbox register of the second processor device that the second processor device completed execution of the second binary executable; and
access second result data from a results region of the mailbox register of the second processor device, wherein the second result data comprises a result generated by the second processor device from completed execution of the second binary executable.

19. A system comprising:
a host processor device;
a first processor device coupled to the host processor device by an interconnect, the first processor device comprising:
processor circuitry;
a local memory;
a mailbox manager to:
determine that a ready value in a mailbox register identifies that a first executable is written to a particular location in the mailbox register, wherein the mailbox register is implemented in the local memory, and the first executable is written to the mailbox register by the host processor device;
read the first executable from the particular location in the mailbox register, wherein the processor circuitry is to execute the first executable to generate a result; and
write an execution finished value to the mailbox register based on execution of the executable by the processor circuitry.

20. The system of claim 19, wherein first executable comprises a first portion of an application, the host processor device comprises circuitry to:
access the mailbox register over the interconnect to read a result value posted in the mailbox register by the first processor device based on execution of the first executable;
use the result value in association with execution of a second portion of the application by the host processor device.

21. The system of claim 20, wherein the mailbox register comprises:
a header to identify the mailbox register in the local memory and identify attributes of the mailbox register;
a ready value field for the ready value;
an execution finished value field for the execution finished value;
a received executables region to receive executables, wherein the received executables region comprises the particular location;
an executable offset field to identify where executables are written within the received executables region;
a results region to receive the results value; and
an output offset field to identify where results are written within the results region.

22. The system of claim 19, further comprising a second processor device coupled to the host processor device by a second interconnect, wherein the second processor device comprises a second mailbox register to accept executables from the host processor device over the second interconnect.

23. The system of claim 19, wherein the host processor device comprises a host central processing unit (CPU), and the processor circuitry of the processor device comprises a different type of processing unit.

24. The system of claim 19, wherein interconnect is compliant with a particular interconnect protocol, and the host processor device is to access the mailbox register according to the particular interconnect protocol.

25. The system of claim 24, wherein the particular interconnect protocol comprises one of Peripheral Component Interconnect Express (PCIe) or Compute Express Link (CXL).
